(19) United States
(12) Patent Application Publication
(10) Pub. No.: US 2026/0025807 A1
(43) Pub. Date: Jan. 22, 2026

(54) COMMUNICATION METHOD AND COMMUNICATION APPARATUS

(71) Applicant: HUAWEI TECHNOLOGIES CO., LTD., Shenzhen (CN)

(72) Inventors: Xiaojun Xi, Shenzhen (CN); Xiaoyan Bi, Shanghai (CN); Yong Liu, Shanghai (CN); Yiqun Ge, Ottawa (CA); Wuxian Shi, Ottawa (CA)

(73) Assignee: HUAWEI TECHNOLOGIES CO., LTD., Shenzhen (CN)

(21) Appl. No.: 19/340,168

(22) Filed: Sep. 25, 2025

Related U.S. Application Data
(63) Continuation of application No. PCT/CN2023/084849, filed on Mar. 29, 2023.

(51) Int. Cl. H04W 72/0453; H04B 7/0456; H04L 5/00

(52) U.S. Cl. CPC H04W 72/0453; H04B 7/0456; H04L 5/0048

(57) ABSTRACT

This application provides a communication method and a communication apparatus. The method includes: A network device sends first information to a terminal device, to indicate at least one combination of a first transmit antenna port and a first frequency domain unit that are used by the terminal device to send a reference signal to the network device; each combination includes one first transmit antenna port and one first frequency domain unit; and all first transmit antenna ports in the at least one combination are a part of all transmit antenna ports of the terminal device, and/or all first frequency domain units in the at least one combination are a part of all scheduled frequency domain units. The terminal device sends a first reference signal to the network device based on the at least one combination. The network device determines a first channel matrix based on the first reference signal.

### CROSS-REFERENCE TO RELATED APPLICATIONS

This application is a continuation of International Application No. PCT/CN2023/084849, filed on Mar. 29, 2023, the disclosure of which is hereby incorporated by reference in its entirety.

### TECHNICAL FIELD

This application relates to the communication field, and in particular, to a communication method and a communication apparatus.

### BACKGROUND

In an uplink channel estimation solution, a terminal device, for example, user equipment (UE), may send a reference signal, for example, a sounding reference signal (SRS), to a network device. After receiving the reference signal from the terminal device, the network device may determine a channel matrix based on the reference signal. The channel matrix may indicate channel state information on all transmit antenna ports, all receive antenna ports, and all scheduled frequency domain units.

In some possible design solutions, when sending the reference signal, the terminal device needs to send, in each transmission time interval (TTI), the reference signal on all frequency domain resources that may be for sending the reference signal and all transmit antenna ports that may be for sending the reference signal. However, in the foregoing solution, when a quantity of the transmit antenna ports is large, a plurality of symbols need to be occupied, causing high time domain resource overheads. In addition, in each TTI, for all of different SRS sequences, reference signals need to be sent on frequency domain units allocated to different transmit antenna port groups based on a comb structure. As a result, a large quantity of frequency domain resources are occupied for reference signal sending.

In conclusion, it can be learned that the foregoing channel estimation solution causes a problem of high resource overheads for reference signal transmission.

### SUMMARY

Embodiments of this application provide a communication method and a communication apparatus, to reduce resource overheads in a channel estimation process.

To achieve the foregoing objective, the following technical solutions are used in this application.

According to a first aspect, a communication method is provided. The method may be applied to a terminal device. For example, the method may be performed by the terminal device, may be performed by a part (for example, a chip or a chip system) configured in the terminal device, or may be implemented by a logical module or software that can implement all or some functions of the terminal device. This is not limited in this application. The communication method includes: receiving first information from a network device, where the first information indicates at least one combination of a first transmit antenna port and a first frequency domain unit that are used by the terminal device to send a reference signal to the network device; each combination includes one first transmit antenna port and one first frequency domain unit; and all first transmit antenna ports in the at least one combination are a part of all transmit antenna ports of the terminal device, and/or all first frequency domain units in the at least one combination are a part of all scheduled frequency domain units; and sending a first reference signal to the network device based on the combination that is of the first transmit antenna port and the first frequency domain unit and that is indicated by the first information, where the first reference signal is for determining a first channel matrix, and the first channel matrix indicates channel state information corresponding to all the transmit antenna ports of the terminal device, all receive antenna ports of the network device, and all the scheduled frequency domain units.

Based on the communication method provided in the first aspect, the terminal device may receive the first information from the network device, where the first information may indicate the at least one combination of the first transmit antenna port and the first frequency domain unit. The terminal device sends the first reference signal to the network device based on the at least one combination indicated by the first information, where all the first transmit antenna ports in the at least one combination are the part of all the transmit antenna ports of the terminal device, and/or all the first frequency domain units in the at least one combination are the part of all the scheduled frequency domain units. In this way, the network device indicates, to the terminal device, a transmit antenna port and a frequency domain unit that are for sending the reference signal, so that sending of the reference signal on all the frequency domain units and all the transmit antenna ports can be avoided, thereby reducing resource overheads.

In an embodiment, the first channel matrix is a channel matrix whose dimension is MN*P, where M is a quantity of all the receive antenna ports of the network device, N is a quantity of all the transmit antenna ports of the terminal device, P is a quantity of all the scheduled frequency domain units, and M, N, and P are all positive integers.

In an embodiment, the method provided in the first aspect may further include: receiving second information from the network device, where the second information indicates that one or more of the following occupied by the reference signal change: a transmit antenna port of the terminal device or a frequency domain unit. In this way, the transmit antenna port and/or the frequency domain unit that are/is for sending the reference signal can be adjusted in time based on the channel state information, so that a channel estimation result is more precise.

In an embodiment, the method provided in the first aspect may further include: sending a second reference signal to the network device, where the second reference signal is for determining whether the transmit antenna port that is of the terminal device and that is occupied by the to-be-sent reference signal changes, a transmit antenna port and a frequency domain unit that are occupied by the second reference signal are determined based on a frequency domain selection matrix, the frequency domain selection matrix is obtained by decomposing a frequency domain orthogonal base matrix, the transmit antenna port occupied by the second reference signal is all the transmit antenna ports of the terminal device, and the frequency domain unit occupied by the second reference signal is mutually orthogonal frequency domain units in all the scheduled frequency domain units.

In an embodiment, a third reference signal is sent to the network device, where the third reference signal is for determining whether the transmit antenna port occupied by the to-be-sent reference signal changes, a frequency domain unit occupied by the third reference signal is a second frequency domain unit, a transmit antenna port occupied by the third reference signal is a second transmit antenna port, and a combination of the second frequency domain unit and the second transmit antenna port is different from the combination of the first frequency domain unit and the first transmit antenna port.

In an embodiment, sending the third reference signal to the network device includes: when a current time point reaches a preset moment, it is detected that a modulation and coding scheme is less than a preset modulation and coding threshold, it is detected that a block error rate is greater than a block error rate threshold, it is detected that a signal to interference plus noise ratio is greater than or equal to a noise threshold, or it is detected that a quantity of transmitted streams is less than or equal to a stream quantity threshold, sending the third reference signal to the network device. In this way, the terminal device can send the third reference signal in time when detecting that a channel state deteriorates, so that the network device can obtain a change status of the transmit antenna port of the terminal device or the frequency domain unit in time, thereby further improving precision of the channel estimation result.

In an embodiment, before sending the third reference signal to the network device, the method provided in the first aspect may further include: receiving third information from the network device, where the third information indicates the combination of the second frequency domain unit and the second transmit antenna port. In this way, the network device can configure a resource occupied by the third reference signal, so that a resource conflict can be reduced, thereby improving communication efficiency.

In an embodiment, the method provided in the first aspect may further include: sending a fourth reference signal to the network device, where the fourth reference signal is for determining whether the frequency domain unit occupied by the to-be-sent reference signal changes, a frequency domain unit occupied by the fourth reference signal is a third frequency domain unit, a transmit antenna port occupied by the fourth reference signal is a third transmit antenna port, and frequency domain units in the third frequency domain unit and the first frequency domain unit are different.

In an embodiment, sending the fourth reference signal to the network device may include: when the current time point reaches the preset moment, it is detected that the modulation and coding scheme is less than the preset modulation and coding threshold, it is detected that the block error rate is greater than the block error rate threshold, it is detected that the signal to interference plus noise ratio is greater than or equal to the noise threshold, or it is detected that the quantity of transmitted streams is less than or equal to the stream quantity threshold, sending the fourth reference signal to the network device. In this way, the terminal device can send the fourth reference signal in time when detecting that the channel state deteriorates, so that the network device can obtain the change status of the transmit antenna port or the frequency domain unit in time, thereby further improving the precision of the channel estimation result.

In an embodiment, before sending the fourth reference signal to the network device, the method provided in the first aspect may further include: receiving fourth information from the network device, where the fourth information indicates a combination of the third frequency domain unit and the third transmit antenna port. In this way, the network device can configure a resource occupied by the fourth reference signal, so that the resource conflict can be reduced, thereby improving the communication efficiency.

According to a second aspect, a communication method is provided. The method may be applied to a network device. For example, the method may be performed by the network device, may be performed by a part (for example, a chip or a chip system) configured in the network device, or may be implemented by a logical module or software that can implement all or some functions of the network device. This is not limited in this application. The communication method includes: sending first information to a terminal device, where the first information indicates at least one combination of a first transmit antenna port and a first frequency domain unit that are used by the terminal device to send a reference signal to the network device; each combination includes one first transmit antenna port and one first frequency domain unit; and all first transmit antenna ports in the at least one combination are a part of all transmit antenna ports of the terminal device, and/or all first frequency domain units in the at least one combination are a part of all scheduled frequency domain units; receiving, on the first frequency domain unit, a first reference signal sent through the first transmit antenna port; and determining a first channel matrix based on the first reference signal, where the first channel matrix indicates channel state information corresponding to all the transmit antenna ports of the terminal device, all receive antenna ports of the network device, and all the scheduled frequency domain units.

Based on the communication method provided in the second aspect, the network device may send the first information to the terminal device, where the first information may indicate the at least one combination of the first transmit antenna port and the first frequency domain unit; and receive the first reference signal from the terminal device based on the at least one combination indicated by the first information, where all the first transmit antenna ports in the at least one combination are the part of all the transmit antenna ports of the terminal device, and/or all the first frequency domain units in the at least one combination are the part of all the scheduled frequency domain units. In this way, the network device can indicate, by using the first information, a transmit antenna port and a frequency domain unit that are for sending the reference signal, and receive the first reference signal on the transmit antenna port and the frequency domain unit that are indicated by the first information, so that receiving of the reference signal on all the frequency domain units and all the transmit antenna ports can be avoided, thereby reducing resource overheads.

In an embodiment, the first channel matrix is a channel matrix whose dimension is MN*P, where M is a quantity of all the receive antenna ports of the network device, N is a quantity of all the transmit antenna ports of the terminal device, P is a quantity of all the scheduled frequency domain units, and M, N, and P are all positive integers.

In an embodiment, determining the first channel matrix based on the first reference signal may include: determining a second channel matrix based on the first reference signal, where the second channel matrix is a channel matrix obtained by extending all the transmit antenna ports of the terminal device in frequency domain, and the second channel matrix indicates channel state information corresponding to all the receive antenna ports of the network device, all the transmit antenna ports of the terminal device, and mutually orthogonal frequency domain units in all the scheduled frequency domain units; and determining the first channel matrix based on the second channel matrix.

In an embodiment, determining the first channel matrix based on the second channel matrix may include: obtaining a third channel matrix through estimation based on the second channel matrix, where the third channel matrix is a channel matrix obtained by extending all the transmit antenna ports of the terminal device in frequency domain, and the third channel matrix indicates an estimation result of the channel state information corresponding to all the receive antenna ports of the network device, all the transmit antenna ports of the terminal device, and the orthogonal frequency domain units in all the scheduled frequency domain units; determining a fourth channel matrix based on the third channel matrix, where the fourth channel matrix is a channel matrix obtained by extending all the transmit antenna ports of the terminal device on all the receive antenna ports of the network device; and determining the first channel matrix based on the fourth channel matrix, a frequency domain base matrix, and a frequency domain orthogonal base matrix.

For example, the first channel matrix may satisfy the following relationship:

$$H {1}_{est} = H {1}_{s u b} * V {1}_{s u b}^{- 1} * V 1 ;$$

and H1≈H1ₑₛₜ, where H1ₑₛₜ indicates an estimation result of the channel state information corresponding to all the transmit antenna ports of the terminal device, all the receive antenna ports of the network device, and all the scheduled frequency domain units, H1_{sub} is the fourth channel matrix, V1_{sub} is the frequency domain orthogonal base matrix,

$$V {1}_{s u b}^{- 1}$$

is an inverse matrix of V1_{sub}, V1 is the frequency domain base matrix, and H1 is the first channel matrix.

Both a row quantity and a column quantity of the frequency domain orthogonal base matrix are equal to a quantity of the mutually orthogonal frequency domain units in all the scheduled frequency domain units, and both a row quantity and a column quantity of the inverse matrix of the frequency domain orthogonal base matrix are equal to the quantity of the mutually orthogonal frequency domain units in all the scheduled frequency domain units.

In an embodiment, the third channel matrix may satisfy the following relationship:

$$H {2}_{est} = H {2}_{o b} * V {2}_{s u b}^{- 1} * V 2 ,$$

where H2ₑₛₜ is the third channel matrix, H2_{ob} is the second channel matrix, V2 is a transmit antenna port-frequency domain base matrix of the terminal device, and

$$V {2}_{s u b}^{- 1}$$

is an inverse matrix of a transmit antenna port-frequency domain orthogonal base matrix V2_{sub} of the terminal device.

In an embodiment, both a row quantity and a column quantity of the transmit antenna port-frequency domain orthogonal base matrix V2_{sub} of the terminal device are equal to a quantity of mutually orthogonal channel column vectors in the second channel matrix, and both a row quantity and a column quantity of the inverse matrix

$$V {2}_{s u b}^{- 1}$$

of V2_{sub} are equal to the quantity of mutually orthogonal channel column vectors in the second channel matrix.

In an embodiment, before sending the first information to the terminal device, the method provided in the second aspect may further include: determining the first information based on a fifth channel matrix, where the fifth channel matrix is a channel matrix corresponding to a combination of each of all the receive antenna ports of the network device, each of all the transmit antenna ports of the terminal device, and each of all the scheduled frequency domain units.

In an embodiment, determining the first information based on the fifth channel matrix may include: determining the frequency domain base matrix based on the fifth channel matrix, where a row quantity of the frequency domain base matrix is the same as the quantity of the mutually orthogonal frequency domain units in all the scheduled frequency domain units, and a column quantity of the frequency domain base matrix is the same as a quantity of frequency domain units in all the scheduled frequency domain units; determining a frequency domain selection matrix based on the frequency domain base matrix, where a row quantity of the frequency domain selection matrix is the same as the quantity of all the scheduled frequency domain units, and a column quantity of the frequency domain selection matrix is the same as the quantity of the mutually orthogonal frequency domain units in all the scheduled frequency domain units; and determining the first information based on the frequency domain selection matrix.

In an embodiment, determining the first information based on the frequency domain selection matrix may include: determining a sixth channel matrix in the fifth channel matrix based on the frequency domain selection matrix, where the sixth channel matrix is a channel matrix obtained by extending the fifth channel matrix on all the receive antenna ports of the network device based on all the transmit antenna ports of the terminal device; determining the transmit antenna port-frequency domain base matrix of the terminal device based on the sixth channel matrix, where the transmit antenna port-frequency domain base matrix includes a column vector corresponding to a combination of each of all the transmit antenna ports of the terminal device and each orthogonal frequency domain unit in all the scheduled frequency domain units; decomposing the transmit antenna port-frequency domain base matrix, to obtain a first transmit antenna port-frequency domain selection matrix, where a row quantity of the first transmit antenna port-frequency domain selection matrix is the same as a quantity of mutually orthogonal combinations of a frequency domain unit and a transmit antenna port in the combination of each orthogonal frequency domain unit in all the scheduled frequency domain units and each of the transmit antenna ports, and a column quantity of the first transmit antenna port-frequency domain selection matrix is the same as a quantity of mutually orthogonal transmit antenna ports; and determining the first information based on the first transmit antenna port-frequency domain selection matrix.

In an embodiment, the method provided in the second aspect may further include: when a transmit antenna port and/or a frequency domain unit that are/is for sending the reference signal change/changes, sending second information to the terminal device, where the second information indicates that one or more of the following occupied by the reference signal change: the transmit antenna port of the terminal device or the frequency domain unit. In this way, the transmit antenna port and/or the frequency domain unit that are/is for sending the reference signal can be adjusted in time based on the channel state information, so that a channel estimation result is more precise.

In an embodiment, before sending the second information to the terminal device, the method provided in the second aspect may further include: receiving a second reference signal from the terminal device, where a transmit antenna port and a frequency domain unit that are occupied by the second reference signal are determined based on the frequency domain selection matrix, the transmit antenna port occupied by the second reference signal is all the transmit antenna ports of the terminal device, and the frequency domain unit occupied by the second reference signal is the mutually orthogonal frequency domain units in all the scheduled frequency domain units; determining a seventh channel matrix based on the second reference signal, where the seventh channel matrix is a channel matrix corresponding to a combination of each of all the receive antenna ports of the network device, each of all the transmit antenna ports of the terminal device, and each orthogonal frequency domain unit in all the scheduled frequency domain units; performing orthogonal triangular decomposition on the seventh channel matrix, to obtain a second transmit antenna port-frequency domain selection matrix; and when the first transmit antenna port-frequency domain selection matrix is inconsistent with the second transmit antenna port-frequency domain selection matrix, determining that one or more of the following for sending the reference signal change: the transmit antenna port or the frequency domain unit.

In an embodiment, the method provided in the second aspect may further include: determining an eighth channel matrix based on the second channel matrix and a receive antenna port selection matrix, where the receive antenna port selection matrix is obtained by performing orthogonal triangular decomposition on a receive antenna port base matrix of the network device; determining a ninth channel matrix based on the eighth channel matrix, where the ninth channel matrix is a channel matrix obtained by extending the transmit antenna ports of the terminal device in frequency domain, and the ninth channel matrix indicates the corresponding channel state information on all the receive antenna ports of the network device, all the transmit antenna ports of the terminal device, and the mutually orthogonal frequency domain units in all the scheduled frequency domain units; determining a first error coefficient based on the third channel matrix and the ninth channel matrix, where the first error coefficient indicates an error of the ninth channel matrix relative to the third channel matrix; and when the first error coefficient is greater than or equal to a first error threshold, determining that the transmit antenna port for sending the reference signal changes.

In an embodiment, the ninth channel matrix satisfies the following relationship: H2_{ob_sub}=U2_{sub}*Q*V2_{sub}; and

$$H {2}_{c h e c k} = U 2 * U {2}_{s u b}^{- 1} * H {2}_{ob \_ sub} * V {2}_{s u b}^{- 1} * V 2 ,$$

where H2_{check} is the ninth channel matrix, H2_{ob_sub} is the eighth channel matrix, V2_{sub} is the transmit antenna port-frequency domain orthogonal base matrix of the terminal device, U2_{sub} is a receive antenna port orthogonal base matrix of the network device, Q is a time domain coefficient matrix,

$$U {2}_{s u b}^{- 1}$$

is an inverse matrix of U2_{sub}, U2 is the receive antenna port base matrix of the network device, V2_{sub}⁻¹ is the inverse matrix of V2_{sub}, and V2 is the transmit antenna port-frequency domain base matrix of the terminal device.

In an embodiment, the first error coefficient satisfies the following relationship:

$$E 1 = \frac{\vert H {2}_{e s t} - H {2}_{c h e c k} \vert}{\vert H {2}_{e s t} \vert} ,$$

where E1 is the first error coefficient, H2ₑₛₜ is the third channel matrix, and H2_{check} is the ninth channel matrix.

In an embodiment, the method provided in the second aspect may further include: receiving a third reference signal from the terminal device, where a frequency domain unit occupied by the third reference signal is a second frequency domain unit, a transmit antenna port occupied by the third reference signal is a second transmit antenna port, and a combination of the second frequency domain unit and the second transmit antenna port is different from the combination of the first frequency domain unit and the first transmit antenna port; determining a first channel coefficient on the second transmit antenna port and the second frequency domain unit based on the third reference signal; obtaining a second channel coefficient on the second transmit antenna port and the second frequency domain unit through estimation based on the second channel matrix; determining a second error coefficient based on the first channel coefficient and the second channel coefficient, where the second error coefficient indicates an error of the first channel coefficient relative to the second channel coefficient; and when the second error coefficient is greater than or equal to a second error threshold, determining that the transmit antenna port for sending the reference signal changes.

In an embodiment, the second error coefficient satisfies the following relationship:

$$E 2 = \frac{\vert h {1}_{est} - h {1}_{check} \vert}{\vert h {1}_{est} \vert} ,$$

where E2 is the second error coefficient, h1_{check} is the first channel coefficient, and h1ₑₛₜ is the second channel coefficient.

In an embodiment, before receiving the third reference signal from the terminal device, the method provided in the second aspect may further include: sending third information to the terminal device, where the third information indicates the combination of the second frequency domain unit and the second transmit antenna port. In this way, the network device can configure a resource occupied by the third reference signal, so that a resource conflict can be reduced, thereby improving communication efficiency.

In an embodiment, the method provided in the second aspect may further include: receiving a fourth reference signal from the terminal device, where a frequency domain unit occupied by the fourth reference signal is a third frequency domain unit, a transmit antenna port occupied by the fourth reference signal is a third transmit antenna port, and the third frequency domain unit is different from the first frequency domain unit; determining a third channel coefficient based on the fourth reference signal; estimating a fourth channel coefficient on the third transmit antenna port and the third frequency domain unit based on the second channel matrix; determining a third error coefficient based on the third channel coefficient and the fourth channel coefficient, where the third error coefficient indicates an error of the fourth channel coefficient relative to the third channel coefficient; and when the third error coefficient is greater than or equal to a third error threshold, determining that the frequency domain unit for sending the reference signal changes.

In an embodiment, the third error coefficient satisfies the following relationship:

$$E 3 = \frac{\vert h {2}_{est} - h {2}_{check} \vert}{\vert h {2}_{est} \vert} ,$$

where E3 is the third error coefficient, h2_{check} is the third channel coefficient, and h2ₑₛₜ is the fourth channel coefficient.

In an embodiment, before receiving the fourth reference signal from the terminal device, the method provided in the second aspect may further include: sending fourth information to the terminal device, where the fourth information indicates a combination of the third frequency domain unit and the third transmit antenna port. In this way, the network device can configure a resource occupied by the fourth reference signal, so that the resource conflict can be reduced, thereby improving the communication efficiency.

According to a third aspect, a communication apparatus is provided. The communication apparatus is configured to perform the communication method according to any one of the implementations of the first aspect and the second aspect.

In this application, the communication apparatus in the third aspect may be the terminal device in the first aspect or the network device in the second aspect, a chip (system) or another part or component that may be disposed in the terminal device or the network device, or an apparatus including the terminal device or the network device.

It should be understood that the communication apparatus in the third aspect includes a corresponding module, unit, or means for implementing the communication method according to any one of the first aspect and the second aspect. The module, the unit, or the means may be implemented by hardware, may be implemented by software, or may be implemented by hardware executing corresponding software. The hardware or the software includes one or more modules or units configured to perform the functions in the foregoing communication methods.

According to a fourth aspect, a communication apparatus is provided. The communication apparatus includes a processor, and the processor is configured to perform the communication method according to any one of the possible implementations of the first aspect and the second aspect.

In an embodiment, the communication apparatus in the fourth aspect may further include a transceiver. The transceiver may be a transceiver circuit or an interface circuit. The transceiver may be used by the communication apparatus in the fourth aspect to communicate with another communication apparatus.

In an embodiment, the communication apparatus in the fourth aspect may further include a memory. The memory and the processor may be integrated together, or may be separately disposed. The memory may be configured to store a computer program and/or data in the communication method according to any one of the first aspect and the second aspect.

In this application, the communication apparatus in the fourth aspect may be the terminal device in the first aspect or the network device in the second aspect, a chip (system) or another part or component that may be disposed in the terminal device or the network device, or an apparatus including the terminal device or the network device.

According to a fifth aspect, a communication apparatus is provided. The communication apparatus includes a processor. The processor is coupled to a memory, and the processor is configured to execute a computer program stored in the memory, so that the communication apparatus performs the communication method according to any one of the possible implementations of the first aspect and the second aspect.

In an embodiment, the communication apparatus in the fifth aspect may further include a transceiver. The transceiver may be a transceiver circuit or an interface circuit. The transceiver may be used by the communication apparatus in the fifth aspect to communicate with another communication apparatus.

In this application, the communication apparatus in the fifth aspect may be the terminal device in the first aspect or the network device in the second aspect, a chip (system) or another part or component that may be disposed in the terminal device or the network device, or an apparatus including the terminal device or the network device.

According to a sixth aspect, a communication apparatus is provided, and includes a processor and a memory. The memory is configured to store a computer program. When the processor executes the computer program, the communication apparatus is enabled to perform the communication method according to any one of the implementations of the first aspect and the second aspect.

In an embodiment, the communication apparatus in the sixth aspect may further include a transceiver. The transceiver may be a transceiver circuit or an interface circuit. The transceiver may be used by the communication apparatus in the sixth aspect to communicate with another communication apparatus.

In this application, the communication apparatus in the sixth aspect may be the terminal device in the first aspect or the network device in the second aspect, a chip (system) or another part or component that may be disposed in the terminal device or the network device, or an apparatus including the terminal device or the network device.

According to a seventh aspect, a communication apparatus is provided, and includes a processor. The processor is configured to: be coupled to a memory; and after reading a computer program in the memory, perform, based on the computer program, the communication method according to any one of the implementations of the first aspect and the second aspect.

In an embodiment, the communication apparatus in the seventh aspect may further include a transceiver. The transceiver may be a transceiver circuit or an interface circuit. The transceiver may be used by the communication apparatus in the seventh aspect to communicate with another communication apparatus.

In this application, the communication apparatus in the seventh aspect may be the terminal device in the first aspect or the network device in the second aspect, a chip (system) or another part or component that may be disposed in the terminal device or the network device, or an apparatus including the terminal device or the network device.

According to an eighth aspect, a processor is provided. The processor is configured to perform the communication method according to any one of the possible implementations of the first aspect and the second aspect.

According to a ninth aspect, a communication system is provided. The communication system includes one or more terminal devices and one or more network devices.

According to a tenth aspect, a computer-readable storage medium is provided, and includes a computer program or instructions. When the computer program or the instructions are run on a computer, the computer is enabled to perform the communication method according to any one of the possible implementations of the first aspect and the second aspect.

According to an eleventh aspect, a computer program product is provided, and includes a computer program or instructions. When the computer program or the instructions are run on a computer, the computer is enabled to perform the communication method according to any one of the possible implementations of the first aspect and the second aspect.

In addition, for technical effects the third aspect to the eleventh aspect, refer to the technical effects of the communication method according to any one of the first aspect and the second aspect. Details are not described herein again.

### BRIEF DESCRIPTION OF DRAWINGS

FIG. 1 is a diagram of an architecture of a communication system according to an embodiment of this application;

FIG. 2 is a schematic flowchart of a communication method according to an embodiment of this application;

FIG. 3 is a diagram 1 of channel matrix transformation according to an embodiment of this application;

FIG. 4 is a diagram 2 of channel matrix transformation according to an embodiment of this application;

FIG. 5 is a diagram 3 of channel matrix transformation according to an embodiment of this application;

FIG. 6 is a diagram 4 of channel matrix transformation according to an embodiment of this application;

FIG. 7 is a diagram 5 of channel matrix transformation according to an embodiment of this application;

FIG. 8 is a diagram 6 of channel matrix transformation according to an embodiment of this application;

FIG. 9 is a diagram 7 of channel matrix transformation according to an embodiment of this application;

FIG. 10 is a diagram of a data structure of information #5 according to an embodiment of this application;

FIG. 11 is a diagram of a data structure of information #5 according to an embodiment of this application;

FIG. 12 is a diagram 1 of a reference signal pattern according to an embodiment of this application;

FIG. 13 is a diagram 2 of a reference signal pattern according to an embodiment of this application;

FIG. 14 is a diagram 3 of a reference signal pattern according to an embodiment of this application;

FIG. 15 is a diagram 4 of a reference signal pattern according to an embodiment of this application;

FIG. 16 is a diagram 5 of a reference signal pattern according to an embodiment of this application;

FIG. 17 is a diagram 6 of a reference signal pattern according to an embodiment of this application;

FIG. 18 is a diagram 7 of a reference signal pattern according to an embodiment of this application;

FIG. 19 is a diagram 8 of a reference signal pattern according to an embodiment of this application;

FIG. 20 is a diagram of channel capacities in different solutions according to an embodiment of this application;

FIG. 21 is a diagram 1 of a structure of a communication apparatus according to an embodiment of this application; and

FIG. 22 is a diagram 2 of a structure of a communication apparatus according to an embodiment of this application.

### DESCRIPTION OF EMBODIMENTS

For ease of understanding of embodiments of this application, terms in embodiments of this application are briefly described below.

Frequency domain unit: The frequency domain unit is a unit of a frequency domain resource. One frequency domain unit may be one resource block (RB), one physical resource block (PRB), one resource block group (RBG), one virtual resource block (VRB), or one subcarrier.

Transmit antenna port: is an antenna port used by an information sending device to send information. For an uplink reference signal, the transmit antenna port is a transmit antenna port of a terminal device.

The following describes technical solutions in this application with reference to accompanying drawings.

The technical solutions in embodiments of this application may be applied to various communication systems, for example, a wireless fidelity (Wi-Fi) system, a vehicle to everything (V2X) communication system, a device-to-device (D2D) communication system, an internet of vehicles communication system, a 4th generation (4G) mobile communication system like a long term evolution (LTE) system or a worldwide interoperability for microwave access (WiMAX) communication system, a 5th generation (5G) mobile communication system like a new radio (NR) system, and a future communication system like a 6th generation (6G) mobile communication system.

All aspects, embodiments, or features are presented in this application by describing a system that may include a plurality of devices, components, modules, and the like. It should be appreciated and understood that, each system may include another device, component, module, and the like, and/or may not include all devices, components, modules, and the like discussed with reference to the accompanying drawings. In addition, a combination of these solutions may be further used.

In addition, in embodiments of this application, terms such as “example” and “for example” are for representing giving an example, an illustration, or a description. Any embodiment or design solution described as an “example” in this application should not be explained as being more preferred or having more advantages than another embodiment or design solution. Exactly, the term “example” is for presenting a concept in a specific manner.

In a process of communication between a network device and the terminal device, the network device needs to obtain channel state information. The channel state information may be obtained by using a reference signal.

In an uplink channel estimation solution, the terminal device may send the reference signal, for example, a sounding reference signal (SRS), to the network device. After receiving the reference signal from the terminal device, the network device may determine a channel matrix based on the reference signal. The channel matrix may indicate channel state information on all transmit antenna ports, all receive antenna ports, and all scheduled frequency domain units.

In some possible design solutions, when sending the reference signal, the terminal device needs to send the reference signal on all frequency domain resources that may be for sending the reference signal and all transmit antenna ports that may be for sending the reference signal. An example in which the SRS is implemented by using a comb-2 comb structure and four cyclic shifts (CSs) is used. It is assumed that the terminal device sends SRSs on eight transmit antenna ports (a transmit antenna port 0 to a transmit antenna port 7), and all scheduled frequency domain resources include a frequency domain unit 0 to a frequency domain unit 1319, where each terminal device occupies one time domain symbol, and the following time domain symbol is referred to as a symbol for short. In this case, the transmit antenna ports of the terminal device may be divided into two groups. For example, the transmit antenna port 0 to the transmit antenna port 3 are one group of transmit antenna ports, and the transmit antenna port 4 to the transmit antenna port 7 are one group of transmit antenna ports. Different groups of transmit antenna ports occupy different frequency domain resources, and SRS sequences between different groups are different. For example, as shown in Table 1, if each transmission time interval (TTI), for example, any one of a TTI 1 to a TTI 6, includes a symbol 0 to a symbol 6, the symbol 5 is a guard interval (GI), and a symbol occupied by the terminal device is the symbol 6. An SRS sequence 1 is multiplexed on the transmit antenna port 0 to the transmit antenna port 3 of the terminal device, and frequency domain units for sending a reference signal include frequency domain units 2n−1. An SRS sequence 2 is multiplexed on the transmit antenna port 4 to the transmit antenna port 7 of the terminal device, and frequency domain units for sending a reference signal include frequency domain units 2n. Values of n are 1, . . . , and 658.

Each group of transmit antenna ports is transformed, through cyclic shifts (CSs), to a time domain for resolution, and different CSs in one group of transmit antenna ports correspond to different transmit antenna ports. The reference signal on the transmit antenna port may be for determining channel state information corresponding to a dimension of the transmit antenna port. Channel state information corresponding to a frequency domain may be restored through fast Fourier transform (FFT) interpolation.

However, in the foregoing solution, when a quantity of the transmit antenna ports is large, high time domain resource overheads are caused.

For example, when the SRS is implemented by using the comb-2 comb structure and the four cyclic shifts (CSs), if there are 32 transmit antenna ports for sending reference signals, where in the 32 transmit antenna ports, a transmit antenna port 0 to a transmit antenna port 3 are one group of transmit antenna ports, a transmit antenna port 4 to a transmit antenna port 7 are one group of transmit antenna ports, a transmit antenna port 8 to a transmit antenna port 11 are one group of transmit antenna ports, a transmit antenna port 12 to a transmit antenna port 15 are one group of transmit antenna ports, a transmit antenna port 16 to a transmit antenna port 19 are one group of transmit antenna ports, a transmit antenna port 20 to a transmit antenna port 23 are one group of transmit antenna ports, a transmit antenna port 24 to a transmit antenna port 27 are one group of transmit antenna ports, and a transmit antenna port 28 to a transmit antenna port 31 are one group of transmit antenna ports, time domain symbols for the sending reference signals in each TTI are shown in Table 2 below. As a result, the time domain symbols occupied by the reference signals are four times of the time domain symbols in the case of the eight antenna ports.

TABLE 1

| Frequency | TTI 1 | | | | | TTI 6 | | | |
|---|---|---|---|---|---|---|---|---|---|
| domain | Symbol | | Symbol | Symbol | | Symbol | | Symbol | Symbol |
| unit index | 0 | . . . | 5 | 6 | | 0 | . . . | 5 | 6 |
| 0 | | . . . | GI | | . . . | | | | |
| 1 | | | | Transmit | | | | GI | Transmit |
| | | | | antenna | | | | | antenna |
| | | | | ports | | | | | ports |
| | | | | 0 to 3 | | | | | 0 to 3 |
| 2 | | | | Transmit | | | | | Transmit |
| | | | | antenna | | | | | antenna |
| | | | | ports | | | | | ports |
| | | | | 4 to 7 | | | | | 4 to 7 |
| . . . | | | | Transmit | | . . . | | | Transmit |
| | | | | antenna | | | | | antenna |
| | | | | ports | | | | | ports |
| | | | | 0 to 3 | | | | | 0 to 3 |
| | | | | Transmit | | | | | Transmit |
| | | | | antenna | | | | | antenna |
| | | | | ports | | | | | ports |
| | | | | 4 to 7 | | | | | 4 to 7 |
| | | | | . . . | | | | | . . . |
| | | | | Transmit | | | | | Transmit |
| | | | | antenna | | | | | antenna |
| | | | | ports | | | | | ports |
| | | | | 0 to 3 | | | | | 0 to 3 |
| | | | | Transmit | | | | | Transmit |
| | | | | antenna | | | | | antenna |
| | | | | ports | | | | | ports |
| | | | | 4 to 7 | | | | | 4 to 7 |
| 1317 | | | | Transmit | | | | | Transmit |
| | | | | antenna | | | | | antenna |
| | | | | ports | | | | | ports |
| | | | | 0 to 3 | | | | | 0 to 3 |
| 1318 | | | | Transmit | | | | | Transmit |
| | | | | antenna | | | | | antenna |
| | | | | ports | | | | | ports |
| | | | | 4 to 7 | | | | | 4 to 7 |
| 1319 | | | | | | | | | |

In addition, in the foregoing channel estimation solution, in each TTI, for all of different SRS sequences, reference signals need to be sent on frequency domain units allocated to different transmit antenna port groups based on a comb structure. As a result, a large quantity of frequency domain resources are occupied for reference signal sending.

In conclusion, it can be learned that the foregoing channel estimation solution causes a problem of high resource overheads for reference signal transmission.

To resolve a problem of high resource overheads in a channel estimation process, embodiments of this application provide a communication method. In the communication method, a network device may send first information to a terminal device, where the first information indicates at least one combination of a first transmit antenna port and a first frequency domain unit that are used by the terminal device to send a reference signal to the network device; each of the at least one combination includes one first transmit antenna port and one first frequency domain unit; and all first transmit antenna ports in the at least one combination are a part of all transmit antenna ports of the terminal device, and/or all first frequency domain units in the at least one combination are a part of all scheduled frequency domain units. The terminal device sends a first reference signal to the network device based on the combination that is of the first transmit antenna port and the first frequency domain unit and that is indicated by the first information. The network device may determine a first channel matrix based on the first reference signal, where the first channel matrix indicates channel state information corresponding to all the transmit antenna ports of the terminal device, all receive antenna ports of the network device, and all the scheduled frequency domain units. In this way, the network device indicates, to the terminal device, a transmit antenna port and a frequency domain unit that are for sending the reference signal, so that sending of the reference signal on all the frequency domain units and all the transmit antenna ports can be avoided, thereby reducing resource overheads.

TABLE 2

| Frequency | TTI | | | | | | |
|---|---|---|---|---|---|---|---|
| domain | Symbol | Symbol | Symbol | Symbol | Symbol | Symbol | Symbol |
| unit index | 0 | 1 | 2 | 3 | 4 | 5 | 6 |
| 0 | | | GI | | | | |
| 1 | | | | Transmit | Transmit | Transmit | Transmit |
| | | | | antenna | antenna | antenna | antenna |
| | | | | ports | ports | ports | ports |
| | | | | 0 to 3 | 8 to 11 | 16 to 19 | 24 to 27 |
| 2 | | | | Transmit | Transmit | Transmit | Transmit |
| | | | | antenna | antenna | antenna | antenna |
| | | | | ports | ports | ports | ports |
| | | | | 4 to 7 | 12 to 15 | 20 to 23 | 28 to 31 |
| . . . | | | | Transmit | Transmit | Transmit | Transmit |
| | | | | antenna | antenna | antenna | antenna |
| | | | | ports | ports | ports | ports |
| | | | | 0 to 3 | 8 to 11 | 16 to 19 | 24 to 27 |
| | | | | Transmit | Transmit | Transmit | Transmit |
| | | | | antenna | antenna | antenna | antenna |
| | | | | ports | ports | ports | ports |
| | | | | 4 to 7 | 12 to 15 | 20 to 23 | 28 to 31 |
| | | | | . . . | | . . . | . . . |
| | | | | Transmit | Transmit | Transmit | Transmit |
| | | | | antenna | antenna | antenna | antenna |
| | | | | ports | ports | ports | ports |
| | | | | 0 to 3 | 8 to 11 | 16 to 19 | 24 to 27 |
| | | | | Transmit | Transmit | Transmit | Transmit |
| | | | | antenna | antenna | antenna | antenna |
| | | | | ports | ports | ports | ports |
| | | | | 4 to 7 | 12 to 15 | 20 to 23 | 28 to 31 |
| 1317 | | | | Transmit | Transmit | Transmit | Transmit |
| | | | | antenna | antenna | antenna | antenna |
| | | | | ports | ports | ports | ports |
| | | | | 0 to 3 | 8 to 11 | 16 to 19 | 24 to 27 |
| 1318 | | | | Transmit | Transmit | Transmit | Transmit |
| | | | | antenna | antenna | antenna | antenna |
| | | | | ports | ports | ports | ports |
| | | | | 4 to 7 | 12 to 15 | 20 to 23 | 28 to 31 |
| 1319 | | | | | | | |

The network architecture and the service scenario described in embodiments of this application are intended to describe the technical solutions in embodiments of this application more clearly, and do not constitute a limitation on the technical solutions provided in embodiments of this application. A person of ordinary skill in the art may know that, with the evolution of the network architecture and the emergence of new service scenarios, the technical solutions provided in embodiments of this application are also applicable to similar technical problems.

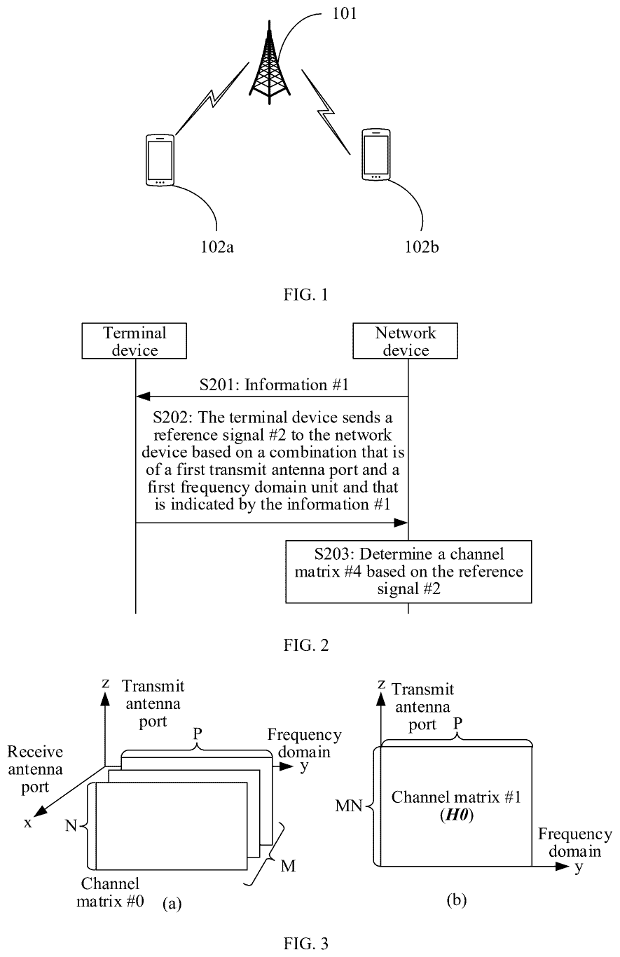

For ease of understanding embodiments of this application, a communication system shown in FIG. 1 is first used as an example to describe in detail a communication system used in embodiments of this application. For example, FIG. 1 is a diagram of an architecture of a communication system to which a communication method according to an embodiment of this application is applicable.

As shown in FIG. 1, the communication system includes a network device 101 and terminal devices (a terminal device 102a and a terminal device 102b).

The terminal devices (the terminal device 102a and the terminal device 102b) may establish communication connections to the network device 101.

The network device is a device that is located on a network side of the communication system and that has a wireless transceiver function, or a chip or a chip system that may be disposed in the device. The network device includes but is not limited to: an access point (AP), for example, a home gateway, a router, a server, a switch, or a bridge, in a wireless fidelity (Wi-Fi) system, an evolved NodeB (eNB), a radio network controller (RNC), a NodeB (NB), a base station controller (BSC), a base transceiver station (BTS), a home base station (for example, a home evolved NodeB, or a home NodeB, HNB), a baseband unit (BBU), a wireless relay node, a wireless backhaul node, a transmission point (transmission and reception point, TRP; or transmission point, TP), or the like, may be a gNB or a transmission point (TRP or TP) in a 5G system, for example, a new radio (NR) system, or one antenna panel or a group of antenna panels (including a plurality of antenna panels) of a base station in a 5G system, or may be a network node, for example, a baseband unit (BBU) or a distributed unit (DU), that constitutes a gNB or a transmission point, a road side unit (RSU) having a base station function, or the like. In another possible scenario, a plurality of RAN nodes coordinate to assist the terminal in implementing radio access, and different RAN nodes separately implement some functions of a base station. For example, the RAN node may be a central unit (CU), a distributed unit (DU), a CU-control plane (CP), a CU-user plane (UP), or a radio unit (RU). The CU and the DU may be separately disposed, or may be included in a same network element, for example, a baseband unit (BBU). The RU may be included in a radio frequency device or a radio frequency unit, for example, included in a remote radio unit (RRU), an active antenna unit (AAU), or a remote radio head (RRH). In different systems, the CU (or the CU-CP and the CU-UP), the DU, or the RU may alternatively have different names, but a person skilled in the art may understand meanings thereof. For example, in an ORAN system, the CU may also be referred to as an open CU (0-CU), the DU may also be referred to as an open DU (0-DU), the CU-CP may also be referred to as an open CU-CP (0-CU-CP), the CU-UP may also be referred to as an open CU-UP (0-CU-UP), and the RU may also be referred to as an open RU (0-RU). Any unit in the CU (or the CU-CP or the CU-UP), the DU, and the RU may be implemented by using a software module, a hardware module, or a combination of the software module and the hardware module.

The terminal device is a terminal that accesses the communication system and that has a wireless transceiver function, or a chip or a chip system that may be disposed in the terminal. The terminal device may also be referred to as user equipment, an access terminal, a subscriber unit, a subscriber station, a mobile station, a remote station, a remote terminal, a mobile device, a user terminal, a terminal, a wireless communication device, or a user agent. The terminal device in embodiments of this application may be a mobile phone, a tablet computer (Pad), a computer having a wireless transceiver function, a virtual reality (VR) terminal device, an augmented reality (AR) terminal device, a wireless terminal in industrial control, a wireless terminal in self driving, a wireless terminal in telemedicine (remote medical), a wireless terminal in a smart grid, a wireless terminal in transportation safety, a wireless terminal in a smart city, a wireless terminal in a smart home, a vehicle-mounted terminal, an RSU having a terminal function, or the like. The terminal device in this application may alternatively be a vehicle-mounted module, a vehicle-mounted assembly, a vehicle-mounted part, a vehicle-mounted chip, or a vehicle-mounted unit that is built in a vehicle as one or more parts or units. The vehicle may implement, by using the vehicle-mounted module, the vehicle-mounted assembly, the vehicle-mounted part, the vehicle-mounted chip, or the vehicle-mounted unit that is built in the vehicle, the communication method provided in this application. In addition, the terminal device may alternatively be a terminal device in an IoT system. An IoT is an important component in future development of information technologies. A main technical feature of the IoT is to connect things to a network by using a communication technology, to implement an intelligent network for human-machine interconnection and thing-thing interconnection. An IoT technology can achieve massive connections, deep coverage, and terminal power saving by using, for example, a narrow band (NB) technology. In addition, the terminal device may further include sensors such as a smart printer, a train detector, and a gas station. Main functions include: collecting data (which is a function of some terminal devices), receiving control information and downlink data of the network device, sending an electromagnetic wave, and transmitting uplink data to the network device. It should be understood that none of specific forms of the network device and the terminal device are limited in this application.

It should be noted that the communication method provided in embodiments of this application is applicable to the network device and the terminal devices shown in FIG. 1. For a specific implementation, refer to the following method embodiment. Details are not described herein again.

It should be noted that the solutions in embodiments of this application may also be applied to another communication system, and a corresponding name may also be replaced with a name of a corresponding function in the another communication system.

It should be understood that FIG. 1 is merely a simplified diagram used as an example for ease of understanding. The communication system may further include another network device and/or another terminal device that are/is not drawn in FIG. 1.

For ease of understanding the method provided in this application, the following several points are first described.

First, for ease of description, the following describes, by using interaction between a network device and a terminal device as an example, the method provided in this application. However, this should not constitute any limitation on a scope to which this application is applicable. A relay device may further assist in communication between the network device and the terminal device. Based on different networking forms, the relay device may implement single-hop forwarding (corresponding to a single-hop relay system), or may implement multi-hop forwarding (corresponding to a multi-hop relay system). This is not limited in this application.

Second, in embodiments of this application, terms such as “first” and “second” are used to distinguish between same objects or similar objects whose functions and purposes are basically the same, to clearly describe the technical solutions in embodiments of this application. For example, first indication information and second indication information are merely for distinguishing between different indication information. A person skilled in the art may understand that “first”, “second”, and the like do not limit a quantity and an execution sequence.

Third, “sending” and “receiving” in embodiments of this application indicate a signal transfer direction. For example, “sending indication information to the terminal device” may be understood as that a destination end of the indication information is the terminal device, and may include direct sending through an air interface, or indirect sending performed by another unit or module through the air interface. “Receiving the indication information from the network device” may be understood as that a source end of the indication information is the network device, and may include direct receiving from the network device through an air interface, or indirect receiving from the network device from another unit or module through the air interface. “Sending” may alternatively be understood as “outputting” of a chip interface, and “receiving” may alternatively be understood as “inputting” of the chip interface.

In other words, sending and receiving may be performed between devices, for example, between the network device and the terminal device; or may be performed inside a device, for example, sending or receiving between components, modules, chips, software modules, or hardware modules inside the device through a bus, a cable, or an interface.

It may be understood that necessary processing, for example, encoding and modulation, may be performed on information between a source end and a destination end of information sending, but the destination end may understand valid information from the source end. Similar descriptions in this application may be understood similarly. Details are not described again.

Fourth, in embodiments of this application, “indication” may include a direct indication and an indirect indication, or may include an explicit indication and an implicit indication. Information indicated by a piece of information (for example, the following indication information) is referred to as to-be-indicated information. In this case, in a specific implementation process, the to-be-indicated information is indicated in a plurality of manners, for example, but not limited to, directly indicating the to-be-indicated information, for example, indicating the to-be-indicated information or an index of the to-be-indicated information. Alternatively, the to-be-indicated information may be indirectly indicated by indicating other information. There is an association relationship between the other information and the to-be-indicated information. Alternatively, only a part of the to-be-indicated information may be indicated, and a remaining part of the to-be-indicated information is known or pre-agreed on. For example, specific information may be indicated by using an arrangement sequence that is of pieces of information and that is pre-agreed on (for example, predefined by using a protocol), to reduce indication overheads to some extent. A specific indication manner is not limited in this application. It may be understood that, for a sender of the indication information, the indication information may indicate the to-be-indicated information; and for a receiver of the indication information, the indication information may be for determining the to-be-indicated information.

Fifth, “at least one” means one or more, and “a plurality of” means two or more than two. “And/or” describes an association relationship between associated objects, and indicates that three relationships may exist. For example, A and/or B may indicate the following cases: Only A exists, both A and B exist, and only B exists, where A and B may be singular or plural. The character “/” generally indicates an “or” relationship between the associated objects. “At least one of the following” or a similar expression thereof indicates any combination of these items, and includes a single item or any combination of plural items. For example, at least one of a, b, or c may indicate a, b, c, a and b, a and c, b and c, or a, b, and c, where a, b, and c may be singular or plural.

The following describes, in detail with reference to the accompanying drawings, the method provided in this application.

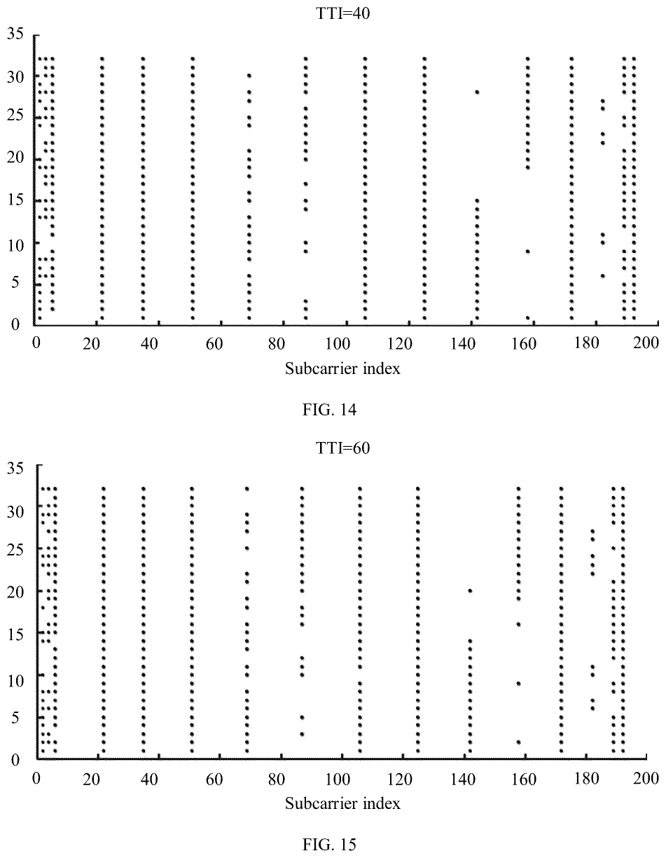

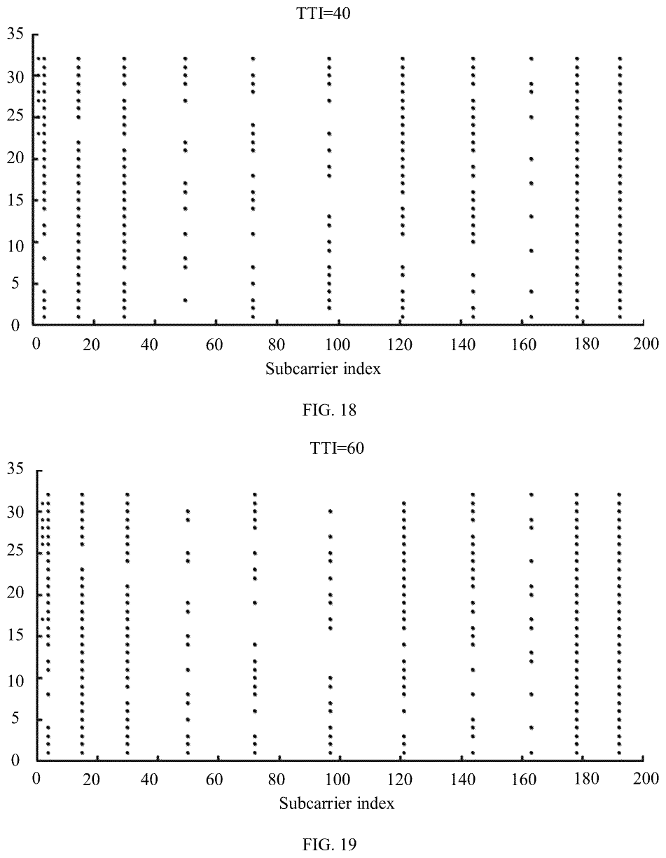

With reference to FIG. 2 to FIG. 20, the following describes in detail the communication method provided in embodiments of this application.

For example, FIG. 2 is a schematic flowchart of a communication method according to an embodiment of this application. The communication method is applicable to communication between the network device and the terminal devices shown in FIG. 1.

As shown in FIG. 2, the communication method includes the following operations.

Operation S201: A network device sends information #1, namely, first information, to a terminal device. Accordingly, the terminal device receives the information #1 from the network device.

The information #1 indicates at least one combination of a transmit antenna port #1 (namely, a first transmit antenna port) and a frequency domain unit #1 (namely, a first frequency domain unit) that are used by the terminal device to send a reference signal to the network device; each combination includes one transmit antenna port #1 and one frequency domain unit #1; and all transmit antenna ports #1 in the at least one combination are a part of all transmit antenna ports of the terminal device, and/or all frequency domain units #1 in the at least one combination are a part of all scheduled frequency domain units.

All the scheduled frequency domain units are frequency domain units that may be for transmission of information between the terminal device and the network device.

That all the transmit antenna ports #1 in the at least one combination are the part of all the transmit antenna ports of the terminal device, and/or all the frequency domain units #1 in the at least one combination are the part of all the scheduled frequency domain units may include any one of the following case 1 to case 3:

Case 1: All the transmit antenna ports #1 in the at least one combination are the part of all the transmit antenna ports of the terminal device, and all the frequency domain units #1 in the at least one combination are the part of all the scheduled frequency domain units.

Case 2: All the transmit antenna ports #1 in the at least one combination are the part of all the transmit antenna ports of the terminal device, and all the frequency domain units #1 in the at least one combination include all the scheduled frequency domain units.

Case 3: All the frequency domain units #1 in the at least one combination are the part of all the scheduled frequency domain units, and all the transmit antenna ports #1 in the at least one combination include all the transmit antenna ports of the terminal device.

It should be noted that, in this embodiment of this application, unless otherwise specified, each transmit antenna port is a transmit antenna port of the terminal device subsequently.

For ease of understanding, based on different cases of the at least one combination, the following describes, by using examples, the transmit antenna port #1, the frequency domain unit #1, the at least one combination indicated by the information #1.

It is assumed that all the transmit antenna ports of the terminal device include a transmit antenna port 1 and a transmit antenna port 2, and all the scheduled frequency domain units include a frequency domain unit 1 and a frequency domain unit 2.

When the at least one combination includes the case 1, the transmit antenna port #1, the frequency domain unit #1, and the at least one combination indicated by the information #1 include any one of the following case 1.1 to case 1.4.

Case 1.1: The transmit antenna port #1 includes the transmit antenna port 1, the frequency domain unit #1 includes the frequency domain unit 1, and the at least one combination includes {transmit antenna port 1, frequency domain unit 1}.

Case 1.2: The transmit antenna port #1 includes the transmit antenna port 1, the frequency domain unit #1 includes the frequency domain unit 2, and the at least one combination includes {transmit antenna port 1, frequency domain unit 2}.

Case 1.3: The transmit antenna port #1 includes the transmit antenna port 2, the frequency domain unit #1 includes the frequency domain unit 1, and the at least one combination includes {transmit antenna port 2, frequency domain unit 1}.

Case 1.4: The transmit antenna port #1 includes the transmit antenna port 2, the frequency domain unit #1 includes the frequency domain unit 2, and the at least one combination includes {transmit antenna port 2, frequency domain unit 2}.

When the at least one combination includes the case 2, the transmit antenna port #1, the frequency domain unit #1, and the at least one combination indicated by the information #1 include any one of the following case 2.1 and case 2.2.

Case 2.1: The transmit antenna port #1 includes the transmit antenna port 1, the frequency domain unit #1 includes the frequency domain unit 1 and the frequency domain unit 2, and the at least one combination includes one or more of the following: {transmit antenna port 1, frequency domain unit 1} or {transmit antenna port 1, frequency domain unit 2}.

Case 2.2: The transmit antenna port #1 includes the transmit antenna port 2, the frequency domain unit #1 includes the frequency domain unit 1 and the frequency domain unit 2, and the at least one combination includes one or more of the following: {transmit antenna port 2, frequency domain unit 1} or {transmit antenna port 2, frequency domain unit 2}.

When the at least one combination includes the case 3, the transmit antenna port #1, the frequency domain unit #1, and the at least one combination indicated by the information #1 include any one of the following case 3.1 and case 3.2.

Case 3.1: The transmit antenna port #1 includes the transmit antenna port 1 and the transmit antenna port 2, the frequency domain unit #1 includes the frequency domain unit 1, and the at least one combination includes one or more of the following: {transmit antenna port 1, frequency domain unit 1} or {transmit antenna port 2, frequency domain unit 1}.

Case 3.2: The transmit antenna port #1 includes the transmit antenna port 1 and the transmit antenna port 2, the frequency domain unit #1 includes the frequency domain unit 2, and the at least one combination includes one or more of the following: {transmit antenna port 1, frequency domain unit 2} or {transmit antenna port 2, frequency domain unit 2}.

For example, the information #1 may be carried in one or more of the following: radio resource control (RRC) signaling, a medium access control control element (MAC CE), or downlink control information (DCI).

It may be understood that the information #1 may be determined by the network device. In this case, in an embodiment, before operation S201, the method provided in FIG. 2 may further include operation 1.

Operation 1: The network device determines the information #1 based on a three-dimensional channel matrix #0, namely, a fifth channel matrix.

For example, the channel matrix #0 is a three-dimensional channel matrix corresponding to all receive antenna ports of the network device, all the transmit antenna ports of the terminal device, and all the scheduled frequency domain units, and the channel matrix #0 indicates channel state information corresponding to all the transmit antenna ports of the terminal device, all the receive antenna ports of the network device, and all the scheduled frequency domain units.

In an embodiment, the channel matrix #0 is a three-dimensional channel matrix determined based on a reference signal #1 that is of all the transmit antenna ports of the terminal device on all the scheduled frequency domain units and that is received by all the receive antenna ports of the network device.

In this case, before operation 1, the method provided in FIG. 2 may further include operation 2 and operation 3.

Operation 2: The terminal device sends the reference signal #1 to the network device. Accordingly, the network device receives the reference signal #1 from the terminal device.

The reference signal #1 is the reference signal that is sent by the terminal device on all the transmit antenna ports of the terminal device and all the scheduled frequency domain units and that is received on all the receive antenna ports of the network device.

Operation 3: The network device determines the channel matrix #0 based on the reference signal #1.

For example, the network device may determine, based on a reference signal received on a combination of each of all the transmit antenna ports and each of all the scheduled frequency domain units, a channel coefficient on the combination of each of all the transmit antenna ports and each of all the scheduled frequency domain units, to obtain the channel matrix #0.

It may be understood that, in this case, different transmit antenna ports of the terminal device may occupy different time domain resources, for example, slots, and the reference signal #1 is sent on all the scheduled frequency domain units. In this way, the channel matrix #0 corresponding to all the receive antenna ports of the network device, all the transmit antenna ports of the terminal device, and all the scheduled frequency domain units can be obtained through measurement, thereby improving precision of the channel matrix obtained in this embodiment of this application.

In another possible design solution, the channel matrix #0 may be determined by interpolating a channel matrix obtained based on reference signals on frequency-division multiplexed transmit antenna ports in all the transmit antenna ports. For a specific implementation principle, refer to the related descriptions in Table 1 above. Details are not described herein again.

In still another possible design solution, the channel matrix #0 may be a three-dimensional channel matrix obtained through transformation of a channel matrix determined based on operations S201 to S203 in this embodiment of this application.

The following describes the channel matrix #0 based on the network device and the terminal device.

For example, assuming that a quantity of all the receive antenna ports of the network device is M, a quantity of all the transmit antenna ports of the terminal device is N, and a quantity of all the scheduled frequency domain units is P, a dimension of the channel matrix #0 may be M*N*P. An element in an n^{th} row and a p^{th} column in an m^{th} two-dimensional channel matrix is a channel coefficient h_{m,n,p} corresponding to a combination of an m^{th} receive antenna port, an n^{th} transmit antenna port, and a p^{th} frequency domain unit. As shown in (a) in FIG. 3, an x-axis direction is a dimension of the receive antenna port of the network device, a y-axis direction is a dimension of a frequency domain, and a z-axis direction is a dimension of the transmit antenna port of the terminal device. In this case, the channel matrix #0 may include M two-dimensional channel matrices whose dimension is N*P. The element in the n^{th} row and the p^{th} column in the m^{th} two-dimensional channel matrix is the channel coefficient h_{m,n,p} corresponding to the combination of the m^{th} receive antenna port, the n^{th} transmit antenna port, and the p^{th} frequency domain unit. 0<m≤M, 0<n≤N, 0<p≤P, and M, N, P, m, n, and p are all positive integers.

For ease of understanding, the following further describes the channel matrix #0 by using an example.

Assuming that all the transmit antenna ports of the terminal device include a transmit antenna port 1 and a transmit antenna port 2, all the scheduled frequency domain units include a frequency domain unit 1 to a frequency domain unit 3, and all the receive antenna ports of the network device include a receive antenna port 1 and a receive antenna port 2, the channel matrix #0 includes a two-dimensional channel matrix H_{R1} on the receive antenna port 1 and a two-dimensional channel matrix H_{R2} on the receive antenna port 2, where H_{R1} and H_{R2} are respectively shown in the following formula (1) and formula (2).

$${H}_{R 1} = \{ \begin{matrix}{h}_{1 , 1 , 1} & {h}_{1 , 1 , 2} & {h}_{1 , 1 , 3} \\ {h}_{1 , 2 , 1} & {h}_{1 , 2 , 2} & {h}_{1 , 2 , 3}\end{matrix} \} \qquad ( 1 )$$

$${H}_{R 2} = \{ \begin{matrix}{h}_{2 , 1 , 1} & {h}_{2 , 1 , 2} & {h}_{2 , 1 , 3} \\ {h}_{2 , 2 , 1} & {h}_{2 , 2 , 2} & {h}_{2 , 2 , 3}\end{matrix} \} \qquad ( 2 )$$

In an embodiment, operation 1 may include operation 1.1 to operation 1.3.

Operation 1.1: The network device determines a frequency domain base matrix based on the channel matrix #0.

For example, operation 1.1 may include operation 1.11 and operation 1.12.

Operation 1.11: The network device determines a two-dimensional channel matrix #1 based on the channel matrix #0. In other words, the network device transforms the channel matrix #0 into the two-dimensional channel matrix #1.

The channel matrix #1 indicates the channel state information corresponding to all the transmit antenna ports, all the receive antenna ports, and all the frequency domain units.

In an embodiment, the dimension of the transmit antenna port and the dimension of the receive antenna port that are of the channel matrix #0 may be combined into one dimension. That is, all the transmit antenna ports of the channel matrix #0 are extended on all the receive antenna ports. In this way, the channel matrix #1 can be obtained. In this case, a combination of one transmit antenna port and one receive antenna port corresponds to one channel row vector or one channel column vector of the channel matrix #1. For example, assuming that the combination of the receive antenna port and the transmit antenna port corresponds to the channel row vector of the channel matrix #1, one frequency domain unit corresponds to the channel column vector of the channel matrix #1. In this way, as shown in (b) in FIG. 3, when the quantity of all the receive antenna ports of the network device is M, the quantity of all the transmit antenna ports of the terminal device is N, and the quantity of all the scheduled frequency domain units is P, a dimension of the channel matrix #1 is MN*P.

For ease of understanding, an example in which the channel matrix #1 is obtained by combining the dimension of the transmit antenna port and the dimension of the receive antenna port that are of the channel matrix #0 into one dimension and the dimension of the channel matrix #1 is shown in (b) in FIG. 3 is used for description in all subsequent examples. Details are not described again subsequently. It may be understood that, in actual implementation, the channel matrix #1 may alternatively be a channel matrix obtained by combining other dimensions, for example, the dimension of the transmit antenna port and the dimension of the frequency domain, or the dimension of the receive antenna port and the dimension of the frequency domain, of the channel matrix #0. Details are not described again subsequently.

In this embodiment of this application, combining a dimension A and a dimension B into one dimension may also be referred to as splicing the dimension A and the dimension B or extending the dimension A in the dimension B.

That the channel matrix #0 includes the two-dimensional channel matrix H_{R1} on the receive antenna port 1 and the two-dimensional channel matrix H_{R2} on the receive antenna port 2 is used as an example. A structure of the channel matrix #1 may be shown in the following formula (3):

$$H 1 o = \{ \begin{matrix}{h}_{1 , 1 , 1} & {h}_{1 , 1 , 2} & {h}_{1 , 1 , 3} \\ {h}_{1 , 2 , 1} & {h}_{1 , 2 , 2} & {h}_{1 , 2 , 3} \\ {h}_{2 , 1 , 1} & {h}_{2 , 1 , 2} & {h}_{2 , 1 , 3} \\ {h}_{2 , 2 , 1} & {h}_{2 , 2 , 2} & {h}_{2 , 2 , 3}\end{matrix} \} \qquad ( 3 )$$

H1o is the channel matrix #1.

Operation 1.12: The network device determines the frequency domain base matrix based on the channel matrix #1.

For example, the network device may perform singular value decomposition (SVD) on the channel matrix #1, to obtain the frequency domain base matrix.

For example, the channel matrix #1 and the frequency domain base matrix may satisfy a relationship shown in the following formula (4):

$$H 1 o = G 1 * V 1 \qquad ( 4 )$$

V1 is the frequency domain base matrix, and G1 is a coefficient matrix that corresponds to the frequency domain and that changes with time. G1 is a product of a left singular matrix and a diagonal matrix including a singular value, where the left singular matrix and the singular value are obtained by performing bilateral SVD decomposition on H1o.

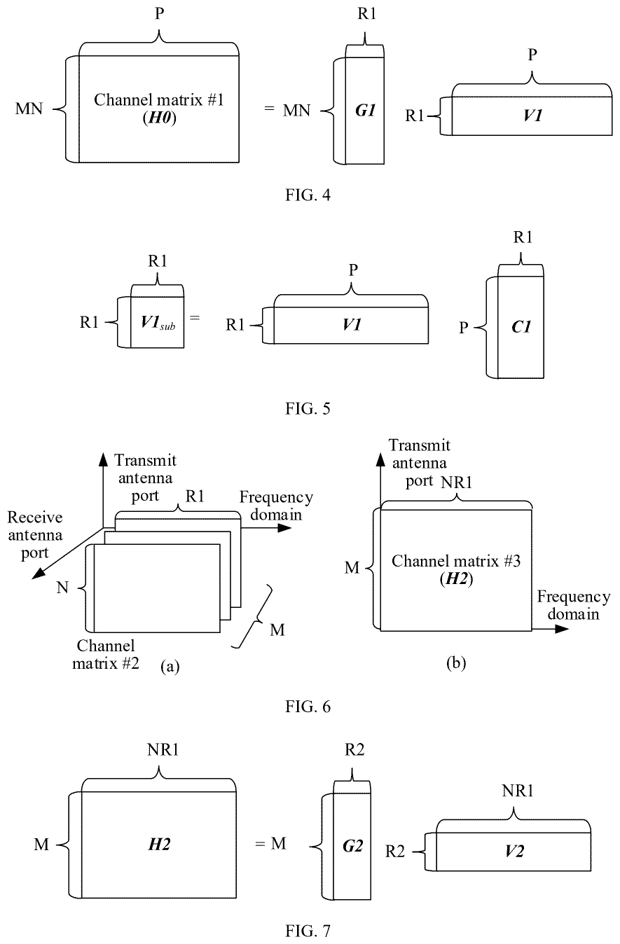

The channel matrix #1 shown in (b) in FIG. 3 is used as an example. As shown in FIG. 4, a dimension of the coefficient matrix that corresponds to the frequency domain and that changes with the time is MN*R1, and a dimension of the frequency domain base matrix is R1*P. R1 is a quantity of mutually orthogonal frequency domain units in all the scheduled frequency domain units (which may also be referred to as mutually orthogonal frequency domain units below). In the following embodiments, each orthogonal frequency domain unit in all the scheduled frequency domain units may be each orthogonal frequency domain unit in all the mutually orthogonal frequency domain units. Each frequency domain unit in the mutually orthogonal frequency domain units may also be referred to as an orthogonal frequency domain unit.

Channel column vectors corresponding to any two frequency domain units in the mutually orthogonal frequency domain units in the channel matrix #1 are mutually orthogonal. That is, an inner product is 0. The foregoing formula (3) is used as an example. Assuming that the frequency domain unit 1 and the frequency domain unit 3 are mutually orthogonal, an inner product of a channel column vector in a 1^{st} column and a channel column vector in a 3^{rd} column that are of the channel matrix #1 is 0.

Operation 1.2: The network device determines a frequency domain selection matrix based on the frequency domain base matrix.

For example, the network device may perform orthogonal triangular (QR) decomposition on the frequency domain base matrix, to obtain the frequency domain selection matrix.

A row quantity of the frequency domain selection matrix is the same as the quantity of all the scheduled frequency domain units, and a column quantity of the frequency domain selection matrix is the same as the quantity of mutually orthogonal frequency domain units in all the scheduled frequency domain units.

The frequency domain selection matrix and the frequency domain base matrix may satisfy a relationship shown in the following formula (5):

$$V {1}_{sub} = V 1 * C 1 \qquad ( 5 )$$

V1_{sub} is a frequency domain orthogonal base matrix.

In an embodiment, both a row quantity and a column quantity of the frequency domain orthogonal base matrix are equal to the quantity of mutually orthogonal frequency domain units in all the scheduled frequency domain units. The frequency domain base matrix shown in FIG. 4 is used as an example. As shown in FIG. 5, a dimension of the frequency domain selection matrix may be P*R1. A dimension of the frequency domain orthogonal base matrix is R1*R1.

Operation 1.3: The network device determines the information #1 based on the frequency domain selection matrix.

The following separately describes operation 1.3 based on a manner 1 and a manner 2.

Manner 1: The information #1 is directly determined based on an element in the frequency domain selection matrix.

It may be understood that, in a scenario in which the frequency domain is stable, the information #1 may be determined in the manner 1. For example, the at least one combination indicated by the information #1 may include a combination of each of frequency domain units corresponding to an element “1” in the frequency domain selection matrix and each of all the transmit antenna ports.

For example, if the quantity of all the transmit antenna ports is N, and the quantity of the scheduled frequency domain units is P, the frequency domain selection matrix may be a matrix whose dimension is P*R1. In the frequency domain selection matrix, a p^{th} row corresponds to a p^{th} frequency domain unit. In this case, in the frequency domain selection matrix C1, a frequency domain unit corresponding to a row in which the element “1” is located is a frequency domain unit occupied by the to-be-sent reference signal. In other words, in a transposed matrix C1^{T} of the frequency domain selection matrix, a frequency domain unit corresponding to a column in which an element “1” is located is the frequency domain unit occupied by the to-be-sent reference signal. Each column in C1^{T} corresponds to one frequency domain unit.

For example, a p^{th} column in C1^{T} corresponds to the p^{th} frequency domain unit. It is assumed that the transposed matrix C1^{T} of the frequency domain selection matrix satisfies a relationship shown in the following formula (6):

$$C {1}^{T} = \{ \begin{matrix}0 & … & 1 & … & 0 & … & 0 & … & 0 \\ 0 & … & 0 & … & 1 & … & 0 & … & 0 \\ … & … & … & … & … & … & … & … & … \\ 0 & … & 0 & … & 0 & … & 1 & … & 0\end{matrix} \} \qquad ( 6 )$$

There are elements “1” in a 3^{rd} column, a 5^{th} column, and an 8^{th} column in the transposed matrix C1^{T} of the frequency domain selection matrix. In this way, it can be determined that frequency domain units for sending the reference signal may include a frequency domain unit 3, a frequency domain unit 5, and a frequency domain unit 8.

Manner 2: A first transmit antenna port-frequency domain selection matrix is determined based on the frequency domain selection matrix, to determine the first information. It may be understood that, in a scenario in which both the frequency domain and the transmit antenna port are stable, the information #1 may be determined in the manner 2.

In an embodiment, operation 1.3 may include operation 1.31 to operation 1.35.

Operation 1.31: The network device determines a three-dimensional channel matrix #2 in the channel matrix #0 based on the frequency domain selection matrix.

The channel matrix #2 indicates channel state information corresponding to all the transmit antenna ports, all the receive antenna ports, and the mutually orthogonal frequency domain units in all the frequency domain units. The channel matrix #2 includes a channel coefficient corresponding to a combination of each of all the receive antenna ports of the network device, each of all the transmit antenna ports of the terminal device, and each frequency domain unit in all the mutually orthogonal frequency domain units.

The formula (6) is used as an example. When a p^{th} column in a transposed matrix of the frequency domain selection matrix includes an element “1”, the channel matrix #2 includes channel column vectors of frequency domain units corresponding to columns in which all elements “1” in C1^{T} are located.

For example, the quantity of all the receive antenna ports of the network device is M, the quantity of all the transmit antenna ports of the terminal device is N, the quantity of all the scheduled frequency domain units is P, and the quantity of mutually orthogonal frequency domain units is R1. As shown in (a) in FIG. 6, the channel matrix #2 may include M two-dimensional channel matrices whose dimension is N*R1. An element in an n^{th} row and an r1^{th} column in an m^{th} two-dimensional channel matrix is a channel coefficient h_{m,n,r1} corresponding to a combination of the m^{th} receive antenna port, the n^{th} transmit antenna port, and an r1^{th} frequency domain unit in all the mutually orthogonal frequency domain units. 0<r1≤R1, and both R1 and r1 are positive integers.

Operation 1.32: The network device determines a two-dimensional channel matrix #3, namely, a sixth channel matrix, based on the channel matrix #2. In other words, the channel matrix #2 is transformed into the channel matrix #3.

The channel matrix #3 indicates the channel state information corresponding to all the transmit antenna ports, all the receive antenna ports, and all the mutually orthogonal frequency domain units. The channel matrix #3 includes all elements in the channel matrix #2. The channel matrix #3 may be a channel matrix obtained by combining a dimension of the transmit antenna port and a dimension of the receive antenna port that are of the channel matrix #2 into one dimension.

For an implementation principle of the channel matrix #3, refer to the related descriptions of the channel matrix #1 in operation 1.11. Details are not described herein again.

The channel matrix #2 shown in (a) in FIG. 6 is used as an example. As shown in (b) in FIG. 6, a dimension of the channel matrix #3 is M*NR1.

Operation 1.33: The network device determines a transmit antenna port-frequency domain base matrix based on the channel matrix #3.

The transmit antenna port-frequency domain base matrix includes a base vector corresponding to a combination of each of all the transmit antenna ports of the terminal device and each frequency domain unit in the mutually orthogonal frequency domain units.

For example, the network device performs SVD decomposition on the channel matrix #3, to obtain the transmit antenna port-frequency domain base matrix of the terminal device. The channel matrix #3 and the transmit antenna port-frequency domain base matrix satisfy a relationship shown in the following formula (7):

$$H 2 = G 2 * V 2 \qquad ( 7 )$$

H2 is the channel matrix #3, G2 is a time domain coefficient matrix corresponding to the transmit antenna port and the frequency domain unit, and V2 is the transmit antenna port-frequency domain base matrix. G2 is a product of a left singular matrix and a diagonal matrix including a singular value, where the left singular matrix and the singular value are obtained by performing bilateral SVD decomposition on H2.

For example, the quantity of all the receive antenna ports of the network device is M, the quantity of all the transmit antenna ports of the terminal device is N, the quantity of all the scheduled frequency domain units is P, and the quantity of mutually orthogonal frequency domain units is R1. As shown in FIG. 7, the dimension of H2 is M*NR1, a dimension of G2 is M*R2, and a dimension of V2 is R2*NR1. R2 is a quantity of mutually orthogonal combinations of a transmit antenna port and a frequency domain unit in the combination of each of the N transmit antenna ports and each of the R1 frequency domain units. R2 is a positive integer.

In the mutually orthogonal combinations of the transmit antenna port and the frequency domain unit, channel vectors corresponding to any two of all combinations of the transmit antenna port and the frequency domain unit are mutually orthogonal. That is, an inner product is 0.

Operation 1.34: The network device determines the first transmit antenna port-frequency domain selection matrix based on the transmit antenna port-frequency domain base matrix.

For example, the network device performs QR decomposition on the transmit antenna port-frequency domain base matrix, to obtain the first transmit antenna port-frequency domain selection matrix. The transmit antenna port-frequency domain base matrix and the first transmit antenna port-frequency domain selection matrix satisfy a relationship shown in the following formula (8):

$$V {2}_{sub} = V 2 * C 2 \qquad ( 8 )$$

V2_{sub} is a transmit antenna port-frequency domain orthogonal base matrix of the terminal device, and C2 is the first transmit antenna port-frequency domain selection matrix.

For example, both a row quantity and a column quantity of the transmit antenna port-frequency domain orthogonal base matrix V2_{sub} of the terminal device are equal to the following: a quantity of orthogonal channel column vectors in a channel matrix obtained by combining a dimension of the transmit antenna port and a dimension of the frequency domain that are of the channel matrix #1.

A row quantity of the first transmit antenna port-frequency domain selection matrix is the same as a quantity of combinations of the mutually orthogonal frequency domain units in all the scheduled frequency domain units and each of all the transmit antenna ports, and a column quantity of the first transmit antenna port-frequency domain selection matrix is the same as the quantity of mutually orthogonal combinations of the transmit antenna port and the frequency domain unit in the combination of each of all the transmit antenna ports and each frequency domain unit in the mutually orthogonal frequency domain units.

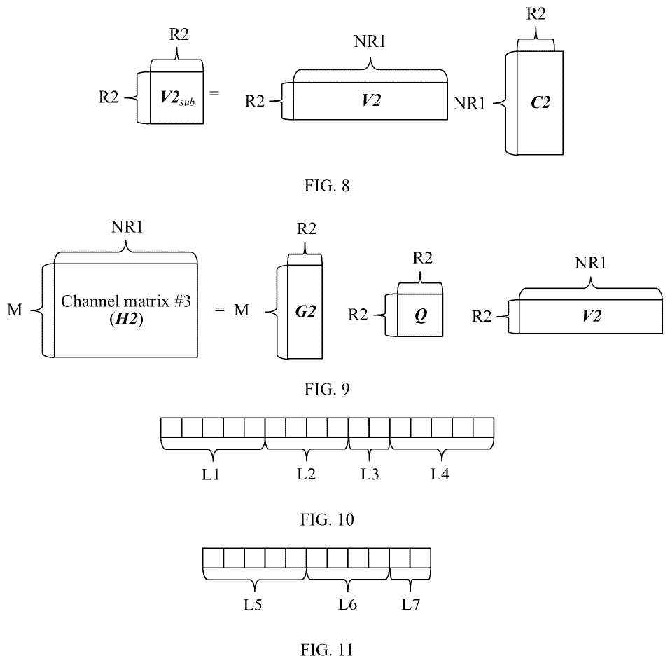

For example, the quantity of all the receive antenna ports of the network device is M, the quantity of all the transmit antenna ports of the terminal device is N, the quantity of all the scheduled frequency domain units is P, the quantity of mutually orthogonal frequency domain units is R1, and the quantity of mutually orthogonal combinations of the transmit antenna port and the frequency domain unit is R2. As shown in FIG. 8, a dimension of V2_{sub} is R2*R2, and a dimension of the first transmit antenna port-frequency domain selection matrix C2 is NR1*R2.

Operation 1.35: The network device determines the information #1 based on the first transmit antenna port-frequency domain selection matrix.

For example, if the quantity of all the transmit antenna ports of the terminal device is N, and the quantity of mutually orthogonal frequency domain units is R1, the first transmit antenna port-frequency domain selection matrix C2 may be a matrix whose dimension is NR1*R2. In this case, an i^{th} row in C2 corresponds to an i^{th} combination of the transmit antenna port and the orthogonal frequency domain unit. A combination that is of a transmit antenna port and an orthogonal frequency domain unit and that corresponds to a row in which an element “1” in C2 is located is a combination of a transmit antenna port and a frequency domain unit that are occupied by the to-be-sent reference signal. In other words, in a transposed matrix C2^{T} of the first transmit antenna port-frequency domain selection matrix, a combination that is of a transmit antenna port and a frequency domain unit and that corresponds to a column in which an element “1” is located is a combination of a transmit antenna port and a frequency domain unit that are for sending the reference signal. A dimension of C2^{T} is R2*NR1, and each column in C2^{T} corresponds to a combination of one transmit antenna port mapped onto the R1 orthogonal frequency domain units and one of all the scheduled frequency domain units.

For example, an index i of a column corresponding to a combination of the n^{th} transmit antenna port and the r1^{th} orthogonal frequency domain unit in C2^{T} satisfies a relationship shown in the following formula (9):

$$i = ( r 1 - 1 ) * N + n \qquad ( 9 )$$

For example, the quantity of all the scheduled frequency domain units is four, and a quantity of orthogonal transmit antenna ports in all the transmit antenna ports is four. C2^{T} satisfies a relationship shown in the following formula (10):

$$C {2}^{T} = \{ \begin{matrix}0 & … & 1 & … & 0 & … & 0 & … & 0 \\ 0 & … & 0 & … & 1 & … & 0 & … & 0 \\ … & … & … & … & … & … & … & … & … \\ 0 & … & 0 & … & 0 & … & 1 & … & 0\end{matrix} \} \qquad ( 10 )$$

In the transposed matrix C2^{T} of the first transmit antenna port-frequency domain selection matrix, columns including elements “1” are a 4^{th} column, a 6^{th} column, and a 9^{th} column. In this way, it can be determined that combinations of the transmit antenna port and the frequency domain unit that are for sending the reference signal include: {transmit antenna port 4, frequency domain unit 1}, {transmit antenna port 2, frequency domain unit 2}, and {transmit antenna port 1, frequency domain unit 3}.

Operation S202: The terminal device sends a reference signal #2, namely, a first reference signal, to the network device based on the combination that is of the transmit antenna port #1 and the frequency domain unit #1 and that is indicated by the information #1. Accordingly, the network device receives the reference signal #2 from the terminal device based on the transmit antenna port #1 and the frequency domain unit #1 that are indicated by the information #1.

For example, when the information #1 is determined in the foregoing manner 1, operation S202 may include: The terminal device may send the reference signal #2 based on a combination of each of all the transmit antenna ports and each frequency domain unit in the mutually orthogonal frequency domain units. Accordingly, the network device receives the reference signal #2 based on the combination of each of all the transmit antenna ports and each frequency domain unit in the mutually orthogonal frequency domain units. In this case, it may be considered that frequency domain compression is performed on the reference signal.

When the first information is determined in the foregoing manner 2, operation S202 may include: The terminal device may send the reference signal #2 based on a combination that is of a transmit antenna port and a frequency domain unit and that corresponds to a column in which the element “1” is located. Accordingly, the network device receives the reference signal #2 based on the combination that is of the transmit antenna port and the frequency domain unit and that corresponds to the column in which the element “1” is located. In this case, it may be considered that frequency domain dimension compression and transmit antenna port dimension compression are sequentially performed on the reference signal.

It may be understood that, in this embodiment of this application, operation S202 may trigger operation S203 below.

Operation S203. The network device determines a channel matrix #4, namely, a first channel matrix, based on the reference signal #2.

The channel matrix #4 indicates the channel state information corresponding to all the transmit antenna ports, all the receive antenna ports, and all the scheduled frequency domain units. In other words, the channel matrix #4 includes a channel coefficient corresponding to a combination of each of all the transmit antenna ports, each of all the receive antenna ports, and each of all the scheduled frequency domain units.

For example, when the quantity of all the transmit antenna ports of the terminal device is N, the quantity of all the receive antenna ports of the network device is M, and the quantity of all the scheduled frequency domain units is P, the first channel matrix may be a two-dimensional channel matrix whose dimension is MN*P or a three-dimensional channel matrix whose dimension is M*N*P. M, N, and P are all positive integers.

In an embodiment, when the information #1 is determined in the manner 2, operation S203 may include operation 4 and operation 5.

Operation 4: The network device determines a two-dimensional channel matrix #5, namely, a second channel matrix, based on the reference signal #2.

The channel matrix #5 is a channel matrix obtained by combining the dimension of the transmit antenna port of the terminal device and the dimension of the frequency domain into one dimension, and the second channel matrix indicates channel state information corresponding to all the receive antenna ports of the network device and the combination that is of the transmit antenna port #1 and the frequency domain unit #1 and that is indicated by the information #1.

A dimension of the channel matrix #5 is M*R2.

The channel matrix #5 satisfies a relationship shown in the following formula (11):

$$H {2}_{ob} = G 2 * V {2}_{sub} \qquad ( 11 )$$

H2_{ob} is the channel matrix #5.

For a specific implementation principle of operation 4, refer to a conventional technology. Details are not described herein again.

Operation 5: The network device determines the channel matrix #4, namely, the first channel matrix, based on the channel matrix #5.

For example, operation 5 may include operation 5.1 to operation 5.3.

Operation 5.1: The network device obtains a channel matrix #6, namely, a third channel matrix, through estimation based on the channel matrix #5.

The channel matrix #6 is a channel matrix obtained by extending all the transmit antenna ports of the terminal device in the dimension of the frequency domain, and the channel matrix #6 indicates an estimation result of the channel state information corresponding to all the receive antenna ports of the network device, all the transmit antenna ports of the terminal device, and the mutually orthogonal frequency domain units in all the scheduled frequency domain units. In other words, the channel matrix #6 includes an estimation result of the channel coefficient corresponding to the combination of each of all the receive antenna ports of the network device, each of all the transmit antenna ports of the terminal device, and each frequency domain unit in the mutually orthogonal frequency domain units.

For example, the quantity of all the receive antenna ports of the network device is M, the quantity of all the transmit antenna ports of the terminal device is N, and the quantity of all the scheduled frequency domain units is P. A dimension of the channel matrix #6 is M*NR1.

In an embodiment, the channel matrix #6 satisfies a relationship shown in the following formula (12):

$$H {2}_{est} = H {2}_{ob} * V {2}_{sub}^{- 1} * V 2 \qquad ( 12 )$$

H2ₑₛₜ is the channel matrix #6, and

$$V {2}_{sub}^{- 1}$$

is an inverse matrix of V2_{sub}.

In an embodiment, both a row quantity and a column quantity of the inverse matrix

$$V {2}_{s u b}^{- 1}$$

of V2_{sub} are equal to a quantity of mutually orthogonal channel column vectors in a channel matrix obtained by combining the dimension of the transmit antenna port and the dimension of the frequency domain that are of the channel matrix #4 into one dimension. For example, the quantity of all the receive antenna ports of the network device is M, the quantity of all the transmit antenna ports of the terminal device is N, the quantity of all the scheduled frequency domain units is P, and the quantity of mutually orthogonal combinations of the transmit antenna port and the frequency domain unit in the channel matrix is R2. A dimension of

$$V {2}_{s u b}^{- 1}$$

### is R2*R2.

Operation 5.2: The network device determines a channel matrix #7, namely, a fourth channel matrix, based on the channel matrix #6.

The channel matrix #7 is a channel matrix obtained by combining a dimension of the transmit antenna port of the terminal device and a dimension of the receive antenna port of the network device that are of the channel matrix #6 into one dimension.

Elements in the channel matrix #7 include all elements in the channel matrix #6. For example, the quantity of all the receive antenna ports of the network device is M, the quantity of all the transmit antenna ports of the terminal device is N, the quantity of all the scheduled frequency domain units is P, and the quantity of mutually orthogonal frequency domain units is R1. A dimension of the channel matrix #7 is MN*R1.

Operation 5.3: The network device determines the channel matrix #4 based on the channel matrix #7, the frequency domain base matrix, and the frequency domain orthogonal base matrix.

In an embodiment, the channel matrix #4 satisfies a relationship shown in the following formula (13) and formula (14):

$$H {1}_{est} = H {1}_{sub} * V {1}_{sub}^{- 1} * V 1 \qquad ( 13 )$$

$$H 1 \approx H {1}_{est} \qquad ( 14 )$$

H1ₑₛₜ indicates an estimation result of the channel state information corresponding to all the transmit antenna ports of the terminal device, all the receive antenna ports of the network device, and all the scheduled frequency domain units, H1_{sub} is the channel matrix #7,

$$V {1}_{s u b}^{- 1}$$

is the inverse matrix of V1_{sub}, and H1 is the channel matrix #4.

In an embodiment, both the row quantity and the column quantity of the inverse matrix of the frequency domain orthogonal base matrix are equal to the quantity of mutually orthogonal frequency domain units in all the scheduled frequency domain units.

For example, the quantity of all the receive antenna ports of the network device is M, the quantity of all the transmit antenna ports of the terminal device is N, the quantity of all the scheduled frequency domain units is P, and the quantity of mutually orthogonal frequency domain units is R1. The dimension of V1_{sub} is R1*R1, and a dimension of

$$V {1}_{s u b}^{- 1}$$

### is R1*R1.

In an embodiment, when the information #1 is determined in the manner 1, operation S203 may include: The network device determines a two-dimensional channel matrix H1_{b} based on the reference signal #2, and determines the first channel matrix based on the two-dimensional channel matrix.

In this case, the channel matrix #5 may satisfy a relationship shown in the following formula (15) and formula (16):

$$H {1}_{est}^{′} = H {1}_{o b} * V {1}_{s u b}^{- 1} * V 1 \qquad ( 15 )$$

$$H 1 \approx H {1}_{est}^{′} \qquad ( 16 )$$

H1_{ob} is the two-dimensional channel matrix determined based on the reference signal #2. H1′ₑₛₜ is a two-dimensional matrix that is determined based on H1_{ob} and that is obtained through frequency domain compression.

For a principle of H1_{ob}, refer to an implementation principle of the channel matrix #0. Details are not described herein again.

Based on the communication method provided in FIG. 2, the terminal device may receive the first information from the network device, where the first information may indicate the at least one combination of the first transmit antenna port and the first frequency domain unit. The terminal device sends the first reference signal to the network device based on the at least one combination indicated by the first information, where all the first transmit antenna ports in the at least one combination are the part of all the transmit antenna ports of the terminal device, and/or all the first frequency domain units in the at least one combination are the part of all the scheduled frequency domain units. In this way, the network device indicates, to the terminal device, the transmit antenna port and the frequency domain unit that are for sending the reference signal, so that sending of the reference signal on all the frequency domain units and all the transmit antenna ports can be avoided, thereby reducing resource overheads.

In addition, when there are a large quantity of transmit antenna ports, and more time domain symbols need to be occupied for implementation, the method provided in FIG. 2 may further reduce a time domain resource occupied by the reference signal, thereby reducing a delay.

For channel state information on a frequency domain resource that is not occupied for sending the reference signal on the transmit antenna port, a channel feature may be obtained based on an obtained channel matrix, thereby determining the channel state information based on the channel feature and a reference signal sent on the part of all the transmit antenna ports and the part of all the scheduled frequency domain units, thereby improving precision of a channel estimation result.

It may be understood that, in this embodiment of this application, the communication method provided in FIG. 2 may further include operation 6.

Operation 6: Update a location of the to-be-sent reference signal.

Operation 6 may be triggered by the network device, operation 6 may be triggered by the terminal device, or operation 6 may be triggered at a preset moment configured by using a protocol.

For ease of understanding, the following describes an update procedure by using examples based on different triggering manners.

Example 1: Operation 6 may be triggered by the network device.

In this case, operation 6 may include the following operation 6.1 to operation 6.4.

Operation 6.1: The terminal device sends a reference signal #3, namely, a second reference signal, to the network device. Accordingly, the network device receives the reference signal #3 from the terminal device.

A transmit antenna port and a frequency domain unit that are occupied by the reference signal #3 are determined in the foregoing manner 1 based on the frequency domain selection matrix, the transmit antenna port occupied by the reference signal #3 is all the transmit antenna ports of the terminal device, and the frequency domain unit occupied by the reference signal #3 is the mutually orthogonal frequency domain units in all the scheduled frequency domain units.

It may be understood that operation 6.1 may trigger operation 6.2.

Operation 6.2: The network device determines a channel matrix #8, namely, a seventh channel matrix, based on the reference signal #3. The channel matrix #8 is a channel matrix corresponding to a combination of each of all the receive antenna ports of the network device, each of all the transmit antenna ports of the terminal device, and each orthogonal frequency domain unit in all the scheduled frequency domain units.

For a structure of the channel matrix #8, refer to the related descriptions of the channel matrix #3. For example, the quantity of all the receive antenna ports of the network device is M, the quantity of all the transmit antenna ports of the terminal device is N, the quantity of all the scheduled frequency domain units is P, and the quantity of mutually orthogonal frequency domain units is R1. A dimension of the channel matrix #8 is M*NR1.

Operation 6.3: The network device performs QR decomposition on the channel matrix #8, to obtain a second transmit antenna port-frequency domain selection matrix.

A dimension of the second transmit antenna port-frequency domain selection matrix is P*R1. For an implementation principle of the second transmit antenna port-frequency domain selection matrix, refer to the first transmit antenna port-frequency domain selection matrix. For an implementation principle of operation 6.3, refer to operation 1.33 and operation 1.34. A difference lies in that the channel matrix #3 is replaced with the channel matrix #8. Details are not described herein again.

Operation 6.4: When the first transmit antenna port-frequency domain selection matrix is inconsistent with the second transmit antenna port-frequency domain selection matrix, the network device determines that one or more of the following for sending the reference signal change: the transmit antenna port or the frequency domain unit.

It may be understood that operation 6.1 to operation 6.4 may also be referred to as a procedure of determining whether to update one or more of the following: the frequency domain unit or the transmit antenna port.

In an embodiment, the method provided in FIG. 2 may further include operation 6.5 to operation 6.8.

Operation 6.5: The network device determines a channel matrix #9, namely, an eighth channel matrix, based on the channel matrix #5 and a receive antenna port selection matrix.

The receive antenna port selection matrix is obtained by performing orthogonal triangular decomposition on a receive antenna port base matrix of the network device.

Each row in the receive antenna port selection matrix corresponds to one receive antenna port, and also corresponds to one row vector in the channel matrix #5. For example, when the quantity of all the transmit antenna ports of the terminal device is N, the quantity of the scheduled frequency domain units is P, and the quantity of orthogonal combinations of the transmit antenna port and the frequency domain unit is R2, the receive antenna port selection matrix may be a matrix whose dimension is R2*M. In the receive antenna port selection matrix, an m^{th} column corresponds to the m^{th} receive antenna port. In this case, the channel matrix #9 includes a row vector that is in the channel matrix #5 and that corresponds to a row in which an element “1” in the receive antenna port selection matrix is located. A dimension of the channel matrix #9 is R2*R2.

For example, the receive antenna port selection matrix may be determined based on the following operation 6.51 and operation 6.52.

Operation 6.51: The network device performs bilateral SVD decomposition on the channel matrix #3, to obtain the receive antenna port base matrix. A principle of performing bilateral SVD decomposition on the channel matrix #3 is implemented by using the following formula (17):

$$H 2 = U 2 * Q * V 2 \qquad ( 17 )$$

U2 is the receive antenna port base matrix, and Q is a time domain coefficient matrix. Q is a matrix including a singular value obtained by performing bilateral SVD decomposition on H2.

Operation 6.52: The network device performs QR decomposition on the receive antenna port base matrix, to obtain the receive antenna port selection matrix. Performing QR decomposition on the receive antenna port base matrix may be implemented by using the following formula (18):

$$U {2}_{s u b} = C 3 * U 2 \qquad ( 18 )$$

C3 is the receive antenna port selection matrix. The channel matrix #3 shown in (b) in FIG. 6 is used as an example. As shown in FIG. 9, a dimension of U2 is M*R2. The dimension of Q is R2*R2. A dimension of the receive antenna port selection matrix C3 is R2*M.

Operation 6.6: The network device determines a channel matrix #10, namely, a ninth channel matrix, based on the channel matrix #9.

The channel matrix #10 is a channel matrix obtained by extending all the transmit antenna ports of the terminal device in frequency domain, and the channel matrix #10 indicates the corresponding channel state information on all the receive antenna ports of the network device, all the transmit antenna ports of the terminal device, and the mutually orthogonal frequency domain units in all the scheduled frequency domain units.

For example, the channel matrix #10 satisfies a relationship shown in the following formula (19) and formula (20):

$$H {2}_{ob \_ sub} = U {2}_{s u b} * Q * V {2}_{s u b} \qquad ( 19 )$$

$$H {2}_{c h e c k} = U 2 * U {2}_{s u b}^{- 1} * H {2}_{ob \_ sub} * V {2}_{s u b}^{- 1} * V 2 \qquad ( 20 )$$

H2_{check} is the channel matrix #10, H2_{ob_sub} is the channel matrix #9, U2_{sub} is a receive antenna port orthogonal base matrix of the network device, and

$$U {2}_{s u b}^{- 1}$$

is an inverse matrix of U2_{sub}.

The channel matrix #10 indicates the channel state information corresponding to all the transmit antenna ports, all the receive antenna ports, and the mutually orthogonal frequency domain units in all the frequency domain units. The channel matrix #10 may be a channel matrix obtained by combining a dimension of the transmit antenna port and a dimension of the receive antenna port into one dimension. A dimension of the channel matrix #10 is M*NR1. For a structure of the channel matrix #10, refer to the channel matrix #3. Details are not described herein again.

Operation 6.7: The network device determines an error coefficient #1, namely, a first error coefficient, based on the channel matrix #6 and the channel matrix #10. The error coefficient #1 indicates an error of the ninth channel matrix relative to the third channel matrix.

For example, the error coefficient #1 satisfies a relationship shown in the following formula (21):

$$E 1 = \frac{{\vert H {2}_{e s t} - H {2}_{c h e c k} \vert}_{2}}{{\vert H {2}_{e s t} \vert}_{2}} \qquad ( 21 )$$

E1 is the error coefficient #1, and “|.|₂” is a matrix 2-norm operation.

Operation 6.8: When the error coefficient #1 is greater than or equal to an error threshold #1, the network device determines that the transmit antenna port for sending the reference signal changes.

For example, the error threshold #1 may be less than or equal to 5%. It may be understood that a value of the error threshold #1 herein is merely used as an example. In actual implementation, the value of the error threshold #1 may be determined based on an actual case. Details are not described herein again.

Operation 6.5 to operation 6.8 may also be referred to as a procedure of determining whether the transmit antenna port for sending the reference signal changes.

In an embodiment, the method provided in FIG. 2 may further include operation 6.9 to operation 6.13.

Operation 6.9: The terminal device sends a reference signal #4, namely, a fourth reference signal, to the network device. Accordingly, the network device receives the reference signal #4 from the terminal device.

A frequency domain unit occupied by the reference signal #4 is a frequency domain unit #2, namely, a third frequency domain unit, and a transmit antenna port occupied by the reference signal #4 is a transmit antenna port #2, namely, a third transmit antenna port. Frequency domain units in the frequency domain unit #2 and the frequency domain unit #1 are different.

Operation 6.10: The network device determines a channel coefficient #1, namely, a third channel coefficient, based on the reference signal #4.

Operation 6.11: The network device estimates a channel coefficient #2, namely, a fourth channel coefficient, on the transmit antenna port #2 and the frequency domain unit #2 based on the channel matrix #5.

Operation 6.12: The network device determines an error coefficient #2, namely, a third error coefficient, based on the channel coefficient #1 and the channel coefficient #2. The error coefficient #2 indicates an error of the fourth channel coefficient relative to the third channel coefficient.

For example, the error coefficient #2 satisfies a relationship shown in the following formula (22):

$$E 3 = \frac{{\vert h {2}_{e s t} - h {2}_{c h e c k} \vert}_{2}}{{\vert h {2}_{e s t} \vert}_{2}} \qquad ( 22 )$$

E3 is the error coefficient #2, h2_{check} is the channel coefficient #1, and h2ₑₛₜ is the channel coefficient #2.

Operation 6.13: When the third error coefficient #2 is greater than or equal to an error threshold #2, namely, a third error threshold, the network device determines that the frequency domain unit for sending the reference signal changes.

For example, the error threshold #2 may be less than or equal to 5%. It may be understood that a value of the error threshold #2 herein is merely used as an example. In actual implementation, the value of the error threshold #2 may be determined based on an actual case. Details are not described herein again.

In an embodiment, before operation 6.9, the method provided in FIG. 2 may further include operation 6.14.

Operation 6.14: The network device sends information #2, namely, fourth information, to the terminal device. Accordingly, the terminal device receives the information #2 from the network device.

The information #2 indicates a combination of the frequency domain unit #2 and the transmit antenna port #2.

For example, the information #2 may be carried in one or more of the following: RRC signaling, a MAC CE, or DCI.

It should be noted that, in this embodiment of this application, an execution sequence of operation 6.5 to operation 6.8 and operation 6.9 to operation 6.13 is not limited, provided that the execution sequence is logical. For example, operation 6.9 may be performed before operation 6.5. This is not limited in this embodiment of this application.

In this way, the network device can configure a resource occupied by a third reference signal, so that a resource conflict can be reduced, thereby improving communication efficiency.

In addition, in this embodiment of this application, operation 6.5 to operation 6.8 and operation 6.9 to operation 6.13 may be performed when operation 6.1 to operation 6.4 are not performed.

Example 2: Operation 6 is triggered by the terminal device.

In this case, the method provided in FIG. 2 may further include operation 6.15.

Operation 6.15: The terminal device sends a reference signal #5, namely, a third reference signal, to the network device. Accordingly, the network device receives the reference signal #5 from the terminal device.

A frequency domain unit occupied by the reference signal #5 is a frequency domain unit #3, namely, a second frequency domain unit, and a transmit antenna port occupied by the reference signal #5 is a transmit antenna port #3, namely, a second transmit antenna port. A combination of the frequency domain unit #3 and the transmit antenna port #3 is different from the combination of the frequency domain unit #1 and the transmit antenna port #1.

In this way, the network device can configure a resource occupied by the reference signal #5, so that a resource conflict can be reduced, thereby improving communication efficiency.

In an embodiment, in operation 6.15, that the terminal device sends the reference signal #5 to the network device may include: When the terminal device detects that a modulation and coding scheme is less than a preset modulation and coding threshold, the terminal device detects that a block error rate is greater than a block error rate threshold, the terminal device detects that a signal to interference plus noise ratio is greater than or equal to a noise threshold, or the terminal device detects that a quantity of transmitted streams is less than or equal to a stream quantity threshold, the terminal device sends the reference signal #5 to the network device.

In this way, the terminal device can send the reference signal #5 in time when detecting that a channel state deteriorates, so that the network device can obtain a change status of the transmit antenna port or the frequency domain unit in time, thereby further improving the precision of the channel estimation result.

It may be understood that operation 6.15 may trigger operation 6.16.

Operation 6.16: The network device determines a channel coefficient #3 on the transmit antenna port #3 and the frequency domain unit #3 based on the reference signal #5.

Operation 6.17: The network device obtains a channel coefficient #4 on the transmit antenna port #3 and the frequency domain unit #3 through estimation based on the channel matrix #5.

Operation 6.18: The network device determines an error coefficient #3, namely, a second error coefficient, based on the channel coefficient #3 and the channel coefficient #4. The error coefficient #3 indicates an error of a first channel coefficient relative to a second channel coefficient.

For example, the error coefficient #3 satisfies a relationship shown in the following formula (23):

$$E 2 = \frac{{\vert h {1}_{e s t} - h {1}_{c h e c k} \vert}_{2}}{{\vert h {1}_{e s t} \vert}_{2}} \qquad ( 23 )$$

E2 is the error coefficient #3, h1_{check} is the channel coefficient #3, and h1ₑₛₜ is the channel coefficient #4.

Operation 6.19: When the error coefficient #3 is greater than or equal to an error threshold #3, namely, a second error threshold, the network device determines that the transmit antenna port for sending the reference signal changes.

For example, the error threshold #3 may be less than or equal to 5%. It may be understood that a value of the error threshold #3 herein is merely used as an example. In actual implementation, the value of the error threshold #3 may be determined based on an actual case. Details are not described herein again.

In an embodiment, before operation 6.15, the method provided in FIG. 2 may further include operation 6.20.

Operation 6.20: The network device sends information #3, namely, third information, to the terminal device. Accordingly, the terminal device receives the information #3 from the network device.

The information #3 indicates the combination of the frequency domain unit #3 and the transmit antenna port #3. For example, the information #3 may be carried in one or more of the following: RRC signaling, a MAC CE, or DCI.

In addition, In an embodiment, the method provided in FIG. 2 may further include operation 6.21.

Operation 6.21: The terminal device sends a reference signal #4, namely, a fourth reference signal, to the network device. Accordingly, the network device receives the reference signal #4 from the terminal device.

In this way, the network device can configure a resource occupied by the reference signal #4, so that a resource conflict can be reduced, thereby improving communication efficiency.

In operation 6.21, that the terminal device sends the reference signal #4 to the network device includes: When the terminal device detects that the modulation and coding scheme is less than the preset modulation and coding threshold, the terminal device detects that the block error rate is greater than the block error rate threshold, the terminal device detects that the signal to interference plus noise ratio is greater than or equal to the noise threshold, or the terminal device detects that the quantity of transmitted streams is less than or equal to the stream quantity threshold, the terminal device sends the reference signal #4 to the network device. For a specific implementation principle of sending the reference signal #4 by the terminal device to the network device, refer to operation 6.9 in the example 1. Details are not described herein again.

In this way, the terminal device can send the reference signal #4 in time when detecting that the channel state deteriorates, so that the network device can obtain the change status of the transmit antenna port or the frequency domain unit in time, thereby further improving the precision of the channel estimation result.

Example 3: Operation 6 may be triggered at the preset moment configured by using the protocol.

In this case, a start moment and a time interval may be preconfigured in the network device and the terminal device, to configure the preset moment by using the protocol. In other words, the preset moment may be determined based on the start moment and the time interval. It may be understood that the start moment may be a start moment of a slot, and the time interval may be an interval slot between a moment at which operation 6 is performed and the start moment. Alternatively, the start moment may be a start moment of a transmission time interval (TTI), and the time interval may be a TTI between a moment at which operation 6 is performed and the start moment.

The slot is used as an example. Assuming that the start moment configured by using the protocol is a start moment of a slot 0, and the time interval is three slots, the preset moment is a start moment of a slot 3.

It may be understood that an implementation that is of the preset moment and that is exemplified in the example 3 is merely used as an example. In actual implementation, the preset moment may alternatively be implemented in another manner. For example, the preset moment is directly configured by using the protocol. Details are not described herein again.

In this case, operation 6 may include: when a current moment reaches the preset moment, updating the location of the to-be-sent reference signal.

For an implementation principle of determining, by the network device, whether at least one of the transmit antenna port or the frequency domain unit that is for sending the reference signal changes, refer to the related descriptions in the example 2. A difference lies in that, in operation 6.21, that the terminal device sends the reference signal #4 to the network device includes: When the current moment reaches the preset moment, the terminal device sends the reference signal #4 to the network device.

In operation 6.15, that the terminal device sends the reference signal #5 to the network device may include: When the current moment reaches the preset moment, the terminal device sends the reference signal #5 to the network device.

It should be noted that, in this embodiment of this application, a sending sequence of the reference signal #5 and the reference signal #4 is not limited. Details are not described herein again.

It may be understood that, in both of the foregoing solution in which the network device triggers operation 6 and the foregoing solution in which the terminal device triggers operation 6, the network device may determine whether the frequency domain unit changes.

When the frequency domain unit changes, the terminal device may send a reference signal #6 to the network device. The network device obtains a channel matrix #13 based on the reference signal #6; then performs operation 1.2 again based on the channel matrix #13, to obtain a frequency domain selection matrix corresponding to the reference signal #6; and determines an updated frequency domain unit based on the frequency domain selection matrix obtained based on the channel matrix #0 and the frequency domain selection matrix corresponding to the reference signal #6. For an implementation principle of the channel matrix #13, refer to the channel matrix #1. Details are not described herein again.

For example, when an inverse matrix of the frequency domain selection matrix obtained through decomposition of the channel matrix #0 is shown in the formula (6), and the frequency domain selection matrix is shown in the following formula (24), where compared with a frequency domain selection matrix #1, in an inverse matrix of the frequency domain selection matrix corresponding to the reference signal #6, an element “1” in a k^{th} column changes to “0”, an element “0” in a 1^{st} column changes to an element “1”, updated frequency domain units are a k^{th} frequency domain unit and a 1^{st} frequency domain unit. k is a positive integer.

$$C {1}^{T} = \{ \begin{matrix}1 & … & 0 & … & 0 & … & 0 & … & 0 \\ 0 & … & 0 & … & 1 & … & 0 & … & 0 \\ … & … & … & … & … & … & … & … & … \\ 0 & … & 0 & … & 0 & … & 1 & … & 0\end{matrix} \} \qquad ( 24 )$$

When both the frequency domain unit and the transmit antenna port change, the network device may further decompose the frequency domain selection matrix corresponding to the reference signal #6, to obtain a transmit antenna port-frequency domain selection matrix corresponding to the reference signal #6; and then determine the updated frequency domain unit and/or transmit antenna port based on the transmit antenna port-frequency domain selection matrix corresponding to the reference signal #6. For a specific implementation, refer to a determining principle of the updated frequency domain unit. Details are not described herein again.

In addition, the method provided in FIG. 2 may further include operation 7.

Operation 7: The network device sends information #4 to the terminal device. Accordingly, the terminal device receives the information #4 from the network device.

The information #4 indicates a changed dimension in the dimensions for sending the reference signal.

For example, the information #4 may be implemented by using a plurality of bits. For example, the information #4 is implemented by using two bits. A 1^{st} bit in the two bits of the information #4 may indicate whether the transmit antenna port occupied by the to-be-sent reference signal changes, and a 2^{nd} bit in the two bits of the information #4 may indicate whether the frequency domain unit occupied by the to-be-sent reference signal changes. For example, “00” indicates that the transmit antenna port occupied by the to-be-sent reference signal does not change, and the frequency domain unit occupied by the to-be-sent reference signal does not change. In this case, “00” may further indicate that there is another fault in a communication system. “01” indicates that the transmit antenna port occupied by the to-be-sent reference signal does not change. “10” indicates that the frequency domain unit occupied by the to-be-sent reference signal does not change. “11” indicates that both the transmit antenna port occupied by the to-be-sent reference signal and the frequency domain unit occupied by the to-be-sent reference signal change. In this case, the network device needs to send the reference signal on all ports and all subcarriers.

The information #4 is merely used as an example. In actual implementation, the 1^{st} bit may indicate whether the frequency domain unit occupied by the to-be-sent reference signal changes, and the 2^{nd} bit may indicate whether the transmit antenna port occupied by the to-be-sent reference signal changes. In addition, a bit “1” may indicate that a dimension corresponding to the bit does not change, and a bit “0” may indicate that a dimension corresponding to the bit changes. Details are not described herein again.

For example, the information #4 may be carried in one or more of the following: RRC signaling, a MAC CE, or DCI.

It may be understood that, in operation 7, when the transmit antenna port and/or the frequency domain unit that are/is for sending the reference signal change/changes, the network device sends information #5, namely, second information, to the terminal device. Accordingly, the terminal device receives the information #5 from the network device.

In this way, the transmit antenna port and/or the frequency domain unit that are/is for sending the reference signal can be adjusted in time based on the channel state information, so that the channel estimation result is more precise.

The information #5 indicates that one or more of the following occupied by the to-be-sent reference signal change: the transmit antenna port of the terminal device or the frequency domain unit.

In an embodiment, when both the transmit antenna port and the frequency domain unit that are occupied by the to-be-sent reference signal change, the information #5 indicates an updated antenna port in the transmit antenna port occupied by the to-be-sent reference signal and an updated frequency domain unit in the frequency domain unit occupied by the to-be-sent reference signal.

For example, the information #5 may be implemented by using a plurality of bits. For example, the network device includes the M receive antenna ports, the terminal device includes the N transmit antenna ports, and the quantity of all the scheduled frequency domain units is P. As shown in FIG. 10, in the information #5, L1 bits may indicate an index of a frequency domain unit that needs to be updated in all the scheduled frequency domain units, and L2 bits may indicate an index of a frequency domain unit that needs to be replaced in the mutually orthogonal frequency domain units in all the scheduled frequency domain units. L1 satisfies a relationship shown in the following formula (25), and L2 satisfies a relationship shown in the following formula (26):

$$L 1 = ⌊ {log}_{2}^{P} ⌋ \qquad ( 25 )$$

$$L 2 = ⌊ {log}_{2}^{R 1} ⌋ \qquad ( 26 )$$

└ ┘ is a rounding down operator.

In the information #5, L3 bits may further indicate that a quantity of transmit antenna ports needs to decrease or increase. That is, in the information #5, the L3 bits indicate a change status of the transmit antenna port. For example, the L3 bits may be two bits. In this case, when the L3 bits are “00”, it indicates that the reference signal is sent on none of all the transmit antenna ports; when the L3 bits are “01”, it indicates that the quantity of transmit antenna ports occupied by the to-be-sent reference signal decreases; when the L3 bits are “10”, it indicates that the quantity of transmit antenna ports occupied by the to-be-sent reference signal increases; or when the L3 bits are “11”, it indicates that the reference signal is sent on all the transmit antenna ports.

In addition, in the information #5, L4 bits may further indicate an index of a transmit antenna port that needs to be removed or added. It may be understood that, when the L3 bits are “00” or “11”, the information #5 may avoid indicating the index of the transmit antenna port that needs to be removed or added.

It may be understood that the index of the frequency domain unit is another type of an identifier of the frequency domain unit, and the index of the transmit antenna port may also be another type of an identifier of the transmit antenna port.

In another possible design solution, the transmit antenna port occupied by the to-be-sent reference signal changes, and the frequency domain unit occupied by the to-be-sent reference signal does not change. In this case, the information #5 indicates an updated antenna port in the transmit antenna port occupied by the to-be-sent reference signal.

For example, the information #5 may be implemented by using a plurality of bits. For example, the network device includes the M receive antenna ports, the terminal device includes the N transmit antenna ports, and the quantity of all the scheduled frequency domain units is P. As shown in FIG. 11, in the information #5, L5 bits may indicate an index of a frequency domain unit that needs to be updated. L5 satisfies a relationship shown in the following formula (27):

$$L 5 = ⌊ {log}_{2}^{R 1} ⌋ \qquad ( 27 )$$

In the information #5, L6 bits may further indicate that a quantity of transmit antenna ports needs to decrease or increase. That is, in the second information, the L6 bits indicate a change status of the transmit antenna port for sending the reference signal. For an implementation principle of the L6 bits, refer to an implementation principle of the L3 bits. Details are not described herein again.

In addition, in the information #5, L7 bits may further indicate an index of a transmit antenna port that needs to be removed or added. For an implementation principle of the L7 bits, refer to an implementation principle of the L4 bits. Details are not described herein again.

For example, the information #5 may be carried in one or more of the following: RRC signaling, a MAC CE, or DCI.

It should be noted that, in this embodiment of this application, the communication method provided in FIG. 2 may be repeatedly performed. For example, a time interval between moments at which the communication method shown in FIG. 2 starts to be performed twice may be a plurality of TTIs. The plurality of TTIs may be agreed on by using a protocol or preconfigured, which is not limited herein. In this way, more accurate channel information can be obtained, thereby improving the precision of the channel estimation result.

For ease of understanding of embodiments of this application, the following describes the solutions in embodiments of this application based on simulation results of a 3rd generation partnership project cluster delay line-A type (3GPP CDL-A) channel and a 10 gigahertz urban macrocell non-line-of-sight (10G UMa NLOS) channel. A frequency domain unit is a subcarrier, and parameter values for simulation are shown in Table 3 below.

TABLE 3

| Parameter | Value |
|---|---|
| Scenario | One network device and one terminal device |
| Channel model | CDL-A/10G UMa NLOS in 3GPP 38.901 |
| Subcarrier Frequency | 10 GHz center frequency and 30 kHz |
| | subcarrier spacing |
| Bandwidth | 16 resource blocks (RBs) |
| Channel assumption | NLOS |
| Antenna configuration of | 32: (M′, N′, P′) = (4, 4, 2); |
| the terminal device | and (dH, dV) = (0.5, 0.5)λ |
| Antenna configuration | 1024: (M′, N′, P′) = (8, 64, 2); |
| of the network device | and (dH, dV) = (0.5, 0.5)λ |
| Standard channel | 460 paths: 23 clusters with 20 |
| | propagation rays (rays) |

The antenna configuration (antenna config) of the terminal device is “quantity 32 of transmit antenna ports: (quantity M′ of transmit antenna ports in a horizontal direction, quantity N′ of transmit antenna ports in a vertical direction, quantity P′ of polarizations)=(4, 4, 2); and (spacing dH between every two elements in the horizontal direction, spacing dV between every two elements in the vertical direction)=(0.5, 0.5)λ”. λ is a wavelength. The antenna configuration of the network device is “quantity 1024 of transmit antenna ports: (quantity M′ of transmit antenna ports in the horizontal direction, quantity N′ of transmit antenna ports in the vertical direction, quantity P′ of polarizations)=(8, 64, 2); and (spacing dH between every two elements in the horizontal direction, spacing dV between every two elements in the vertical direction)=(0.5, 0.5)λ”. The standard channel is “channel multipath quantity 460 paths: 23 clusters with 20 propagation paths”. That is, the standard channel includes the 23 clusters in total, each cluster includes the 20 propagation paths, and the channel multipath quantity is 460 paths.

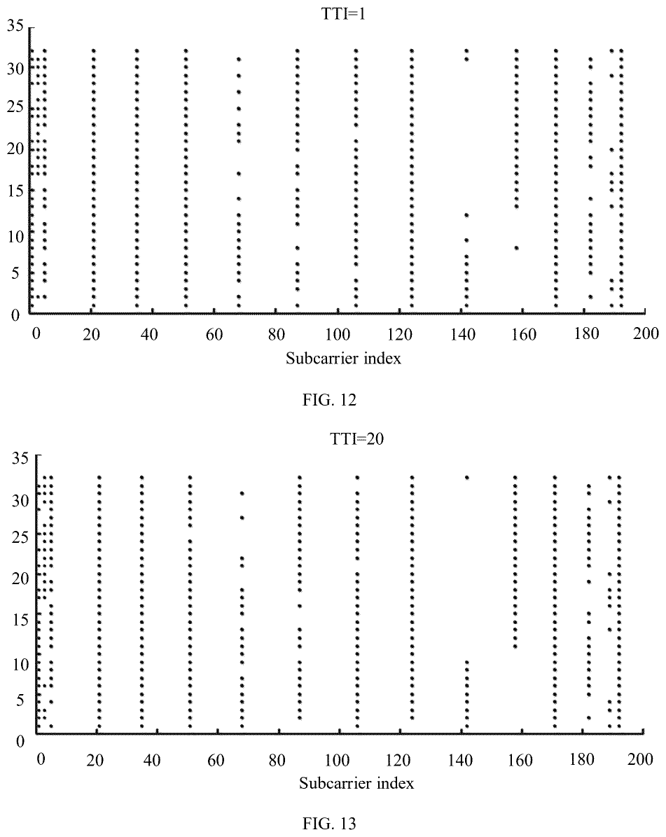

Based on the simulation parameters in Table 3, in a case of the CDL-A channel, reference signal patterns respectively corresponding to TTI=1, TTI=20, TTI=40, and TTI=60 are shown in FIG. 12 to FIG. 15.

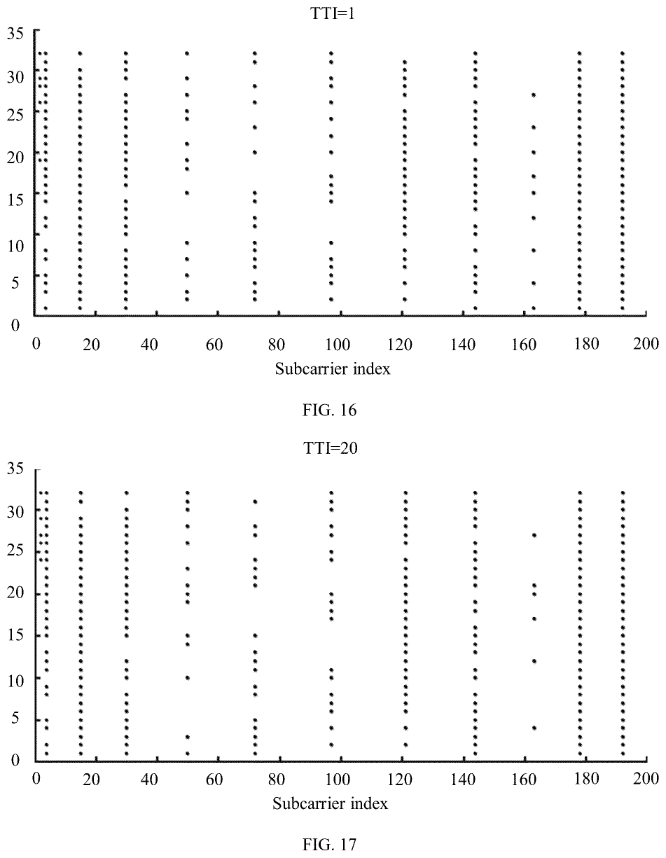

Based on the simulation parameters in Table 3, in a case of the 10G UMa NLOS channel, reference signal patterns respectively corresponding to TTI=1, TTI=20, TTI=40, and TTI=60 are shown in FIG. 16 to FIG. 19.

In FIG. 12 to FIG. 19, a horizontal axis is a subcarrier index, and a vertical axis is a quantity of transmit antenna ports. A reference signal pattern is for displaying a distribution status of subcarriers and transmit antenna ports for sending a reference signal.

With reference to FIG. 12 to FIG. 19, it can be learned that frequency domain units occupied by the reference signal are basically the same in different TTIs, and transmit antenna ports change with the TTIs. In other words, the transmit antenna port needs to be updated with time.

Based on the parameters in Table 3, the 10G UMa NLOS channel, and an SRS with 20 TTIs, overheads of different reference signal sending solutions are shown in Table 4 below. The overheads are all calculated by using a resource unit (RE).

TABLE 4

| | | | | Total |
|---|---|---|---|---|
| | Training | Measurement | Total | overheads |
| | overheads | overheads | overheads | (relative |
| Solution | (RE) | (RE) | (RE) | value) |
| Solution 1: ideal channel | / | 32*192*10 | 61440 | 100% |
| (measurement performed | | | | |
| every 20 TTIs) | | | | |
| Solution 2: frequency | 32*192 | 32*13*9 | 9888 | 16% |
| domain compression | | | | |
| (measurement performed | | | | |
| every 20 TTIs) | | | | |
| Solution 3: frequency | 32*192 + | 254*4 | 9240 | 15% |
| domain compression | 5*32*13 | | | |
| first, and then transmit | | | | |
| antenna port-frequency | | | | |
| domain compression | | | | |
| (measurement performed | | | | |
| every 20 TTIs, and | | | | |
| updating of a coefficient | | | | |
| of a transmit antenna port | | | | |
| every 40 TTIs) | | | | |
| Solution 4: frequency | 32*192 | 254*9 | 8430 | 13% |
| domain compression | | | | |
| first, and then transmit | | | | |
| antenna port-frequency | | | | |
| domain compression | | | | |
| (measurement performed | | | | |
| every 20 TTIs). | | | | |

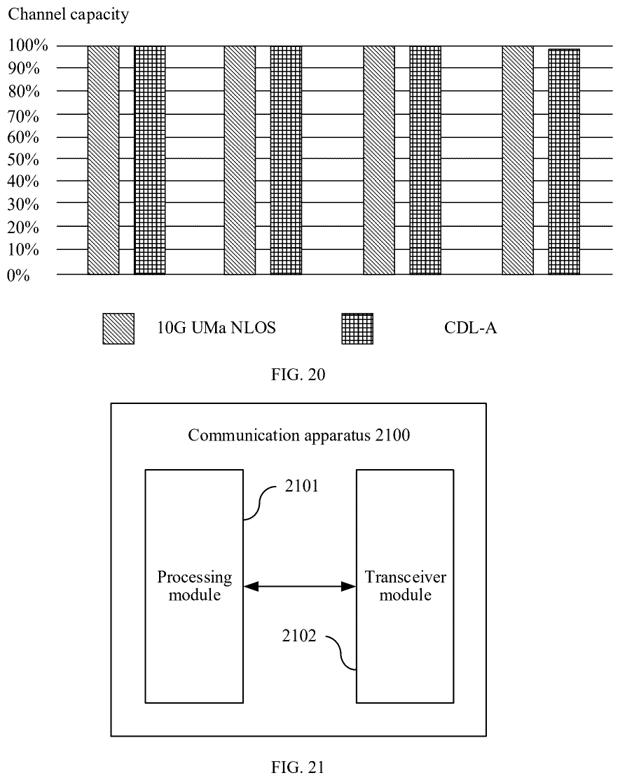

In the four solutions shown in Table 4, channel capacities of each solution in cases of different channels are shown in FIG. 20.

In the case of the 10G UMa NLOS channel, channel capacities of the solution 1 to the solution 4 are respectively 100%, 100%, 100%, and 100%. In the case of the CDL-A channel, channel capacities of the solution 1 to the solution 4 are respectively 100%, 100%, 100%, and 99%.

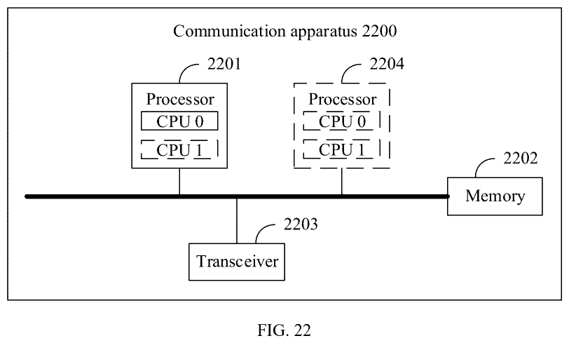

The foregoing describes, in detail with reference to FIG. 2 to FIG. 19, the communication method provided in embodiments of this application. The following describes, in detail with reference to FIG. 21 and FIG. 22, communication apparatuses configured to perform the communication method provided in embodiments of this application.

For example, FIG. 21 is a diagram 1 of a structure of a communication apparatus according to an embodiment of this application. As shown in FIG. 21, the communication apparatus includes a processing module 2101 and a transceiver module 2102. For ease of description, FIG. 21 shows only main parts of the communication apparatus 2100.

In some embodiments, the communication apparatus 2100 may be used in the communication system shown in FIG. 1, and perform a function of the terminal device in the communication method shown in FIG. 2.

The processing module 2101 is configured to receive first information from a network device via the transceiver module 2102, where the first information indicates at least one combination of a first transmit antenna port and a first frequency domain unit that are used by the communication apparatus 2100 to send a reference signal to the network device; each combination includes one first transmit antenna port and one first frequency domain unit; and all first transmit antenna ports in the at least one combination are a part of all transmit antenna ports of the communication apparatus 2100, and/or all first frequency domain units in the at least one combination are a part of all scheduled frequency domain units. The processing module 2101 is further configured to send a first reference signal to the network device via the transceiver module 2102 based on the combination that is of the first transmit antenna port and the first frequency domain unit and that is indicated by the first information, where the first reference signal is for determining a first channel matrix.

The first channel matrix indicates channel state information corresponding to all the transmit antenna ports of the communication apparatus 2100, all receive antenna ports of the network device, and all the scheduled frequency domain units.

In an embodiment, the first channel matrix is a channel matrix whose dimension is MN*P, where M is a quantity of all the receive antenna ports of the network device, N is a quantity of all the transmit antenna ports of the communication apparatus 2100, P is a quantity of all the scheduled frequency domain units, and M, N, and P are all positive integers.

In an embodiment, the processing module 2101 is further configured to receive second information from the network device via the transceiver module 2102, where the second information indicates that one or more of the following occupied by the reference signal change: a transmit antenna port of the terminal device or a frequency domain unit.

In an embodiment, the processing module 2101 is further configured to send a second reference signal to the network device via the transceiver module 2102, where the second reference signal is for determining whether the transmit antenna port that is of the communication apparatus 2100 and that is occupied by the to-be-sent reference signal changes, a transmit antenna port and a frequency domain unit that are occupied by the second reference signal are determined based on a frequency domain selection matrix, the frequency domain selection matrix is obtained by decomposing a frequency domain orthogonal base matrix, the transmit antenna port occupied by the second reference signal is all the transmit antenna ports of the communication apparatus 2100, and the frequency domain unit occupied by the second reference signal is mutually orthogonal frequency domain units in all the scheduled frequency domain units.

In an embodiment, the processing module 2101 is further configured to send a third reference signal to the network device via the transceiver module 2102, where the third reference signal is for determining whether the transmit antenna port occupied by the to-be-sent reference signal changes, a frequency domain unit occupied by the third reference signal is a second frequency domain unit, a transmit antenna port occupied by the third reference signal is a second transmit antenna port, and a combination of the second frequency domain unit and the second transmit antenna port is different from the combination of the first frequency domain unit and the first transmit antenna port.

In an embodiment, the processing module 2101 is further configured to: when a current time point reaches a preset moment, the communication apparatus 2100 detects that a modulation and coding scheme is less than a preset modulation and coding threshold, the communication apparatus 2100 detects that a block error rate is greater than a block error rate threshold, the communication apparatus 2100 detects that a signal to interference plus noise ratio is greater than or equal to a noise threshold, or the communication apparatus 2100 detects that a quantity of transmitted streams is less than or equal to a stream quantity threshold, send the third reference signal to the network device via the transceiver module 2102.

In an embodiment, the processing module 2101 is further configured to receive third information from the network device via the transceiver module 2102, where the third information indicates the combination of the second frequency domain unit and the second transmit antenna port.

In an embodiment, the processing module 2101 is further configured to send a fourth reference signal to the network device via the transceiver module 2102, where the fourth reference signal is for determining whether the frequency domain unit occupied by the to-be-sent reference signal changes, a frequency domain unit occupied by the fourth reference signal is a third frequency domain unit, a transmit antenna port occupied by the fourth reference signal is a third transmit antenna port, and frequency domain units in the third frequency domain unit and the first frequency domain unit are different.

In an embodiment, the processing module 2101 is further configured to: when the current time point reaches the preset moment, the communication apparatus 2100 detects that the modulation and coding scheme is less than the preset modulation and coding threshold, the communication apparatus 2100 detects that the block error rate is greater than the block error rate threshold, the communication apparatus 2100 detects that the signal to interference plus noise ratio is greater than or equal to the noise threshold, or the communication apparatus 2100 detects that the quantity of transmitted streams is less than or equal to the stream quantity threshold, send the fourth reference signal to the network device via the transceiver module 2102.

In an embodiment, the processing module 2101 is further configured to receive fourth information from the network device via the transceiver module 2102, where the fourth information indicates a combination of the third frequency domain unit and the third transmit antenna port.

In an embodiment, the transceiver module 2102 may include a receiving module and a sending module (not shown in FIG. 21). The transceiver module 2102 is configured to implement a sending function and a receiving function of the communication apparatus 2100.

In an embodiment, the communication apparatus 2100 may further include a storage module (not shown in FIG. 21). The storage module stores a program or instructions. When the processing module 2101 executes the program or the instructions, the communication apparatus 2100 is enabled to perform the function of the terminal device in the communication method shown in FIG. 2.

It should be understood that, the processing module 2101 in the communication apparatus 2100 may be implemented by a processor or a processor-related circuit component, and may be a processor or a processing unit; and the transceiver module 2102 may be implemented by a transceiver or a transceiver-related circuit component, and may be a transceiver or a transceiver unit.

It should be noted that, the communication apparatus 2100 may be a terminal device, may be a chip (system) or another part or component that may be disposed in the terminal device, or may be an apparatus including the terminal device. This is not limited in this application.

In addition, for technical effects of the communication apparatus 2100, refer to the technical effects of the communication method shown in FIG. 2. Details are not described herein again.

In some other embodiments, the communication apparatus 2100 may be used in the communication system shown in FIG. 1, and perform a function of the communication apparatus 2100 in the communication method shown in FIG. 2.

The processing module 2101 is configured to send first information to a terminal device via the transceiver module 2102, where the first information indicates at least one combination of a first transmit antenna port and a first frequency domain unit that are used by the terminal device to send a reference signal to the communication apparatus 2100; each combination includes one first transmit antenna port and one first frequency domain unit; and all first transmit antenna ports in the at least one combination are a part of all transmit antenna ports of the terminal device, and/or all first frequency domain units in the at least one combination are a part of all scheduled frequency domain units.

The processing module 2101 is further configured to receive, via the transceiver module 2102 on the first frequency domain unit, a first reference signal sent through the first transmit antenna port.

The processing module 2101 determines a first channel matrix based on the first reference signal, where the first channel matrix indicates channel state information corresponding to all the transmit antenna ports of the terminal device, all receive antenna ports of the communication apparatus 2100, and all the scheduled frequency domain units.

In an embodiment, the first channel matrix is a channel matrix whose dimension is MN*P, where M is a quantity of all the receive antenna ports of the communication apparatus 2100, N is a quantity of all the transmit antenna ports of the terminal device, P is a quantity of all the scheduled frequency domain units, and M, N, and P are all positive integers.

In an embodiment, the processing module 2101 determines a second channel matrix based on the first reference signal, where the second channel matrix is a channel matrix obtained by extending all the transmit antenna ports of the terminal device in frequency domain, and the second channel matrix indicates channel state information corresponding to all the receive antenna ports of the communication apparatus 2100, all the transmit antenna ports of the terminal device, and mutually orthogonal frequency domain units in all the scheduled frequency domain units. The processing module 2101 is further configured to determine the first channel matrix based on the second channel matrix.

In an embodiment, the processing module 2101 is further configured to obtain third channel matrix through estimation based on the second channel matrix, where the third channel matrix is a channel matrix obtained by extending all the transmit antenna ports of the terminal device in frequency domain, and the third channel matrix indicates an estimation result of the channel state information corresponding to all the receive antenna ports of the communication apparatus 2100, all the transmit antenna ports of the terminal device, and the mutually orthogonal frequency domain units in all the scheduled frequency domain units. The processing module 2101 is further configured to determine a fourth channel matrix based on the third channel matrix, where the fourth channel matrix is a channel matrix obtained by extending all the transmit antenna ports of the terminal device on all the receive antenna ports of the communication apparatus 2100. The processing module 2101 is further configured to determine the first channel matrix based on the fourth channel matrix, a frequency domain base matrix, and a frequency domain orthogonal base matrix.

For example, the first channel matrix may satisfy the following relationship:

$$H {1}_{est} = H {1}_{sub} * V {1}_{sub}^{- 1} * V 1 ;$$

and H1≈H1ₑₛₜ, where H1ₑₛₜ indicates an estimation result of the channel state information corresponding to all the transmit antenna ports of the terminal device, all the receive antenna ports of the communication apparatus 2100, and all the scheduled frequency domain units, H1_{sub} is the fourth channel matrix, V1_{sub} is the frequency domain orthogonal base matrix

$$V {1}_{sub}^{- 1}$$

is an inverse matrix of V1_{sub}, V1 is the frequency domain base matrix, and H1 is the first channel matrix.

Both a row quantity and a column quantity of the frequency domain orthogonal base matrix are equal to a quantity of the mutually orthogonal frequency domain units in all the scheduled frequency domain units, and both a row quantity and a column quantity of the inverse matrix of the frequency domain orthogonal base matrix are equal to the quantity of the mutually orthogonal frequency domain units in all the scheduled frequency domain units.

In an embodiment, the third channel matrix may satisfy the following relationship:

$$H {2}_{est} = H {2}_{ob} * V {2}_{sub}^{- 1} * V 2 ,$$

where H2ₑₛₜ is the third channel matrix, H2_{ob} is the second channel matrix, V2 is a transmit antenna port-frequency domain base matrix of the terminal device, and

$$V {2}_{sub}^{- 1}$$

is an inverse matrix of a transmit antenna port-frequency domain orthogonal base matrix V2_{sub} of the terminal device.

In an embodiment, both a row quantity and a column quantity of the transmit antenna port-frequency domain orthogonal base matrix V2_{sub} of the terminal device are equal to a quantity of mutually orthogonal channel column vectors in the channel matrix obtained by extending the first channel matrix in frequency domain based on the transmit antenna ports, and both a row quantity and a column quantity of the inverse matrix

$$V {2}_{sub}^{- 1}$$

of V2_{sub} are equal to the quantity of mutually orthogonal channel column vectors in the channel matrix obtained by extending the first channel matrix in frequency domain based on the transmit antenna ports.

In an embodiment, the processing module 2101 is further configured to determine the first information based on a fifth channel matrix, where the fifth channel matrix is a channel matrix corresponding to a combination of each of all the receive antenna ports of the communication apparatus 2100, each of all the transmit antenna ports of the terminal device, and each of all the scheduled frequency domain units.

In an embodiment, the processing module 2101 is further configured to determine the frequency domain base matrix based on the fifth channel matrix, where a row quantity of the frequency domain base matrix is the same as the quantity of the mutually orthogonal frequency domain units in all the scheduled frequency domain units, and a column quantity of the frequency domain base matrix is the same as a quantity of frequency domain units in all the scheduled frequency domain units. The processing module 2101 is further configured to determine a frequency domain selection matrix based on the frequency domain base matrix, where a row quantity of the frequency domain selection matrix is the same as the quantity of all the scheduled frequency domain units, and a column quantity of the frequency domain selection matrix is the same as the quantity of the mutually orthogonal frequency domain units in all the scheduled frequency domain units. The processing module 2101 is further configured to determine the first information based on the frequency domain selection matrix.

In an embodiment, the processing module 2101 is further configured to determine a sixth channel matrix in the fifth channel matrix based on the frequency domain selection matrix, where the sixth channel matrix is a channel matrix obtained by extending the fifth channel matrix on all the receive antenna ports of the communication apparatus 2100 based on all the transmit antenna ports of the terminal device. The communication apparatus 2100 determines the transmit antenna port-frequency domain base matrix of the terminal device based on the sixth channel matrix, where the transmit antenna port-frequency domain base matrix includes a column vector corresponding to a combination of each of all the transmit antenna ports of the terminal device and each orthogonal frequency domain unit in all the scheduled frequency domain units. The processing module 2101 is further configured to decompose the transmit antenna port-frequency domain base matrix, to obtain a first transmit antenna port-frequency domain selection matrix, where a row quantity of the first transmit antenna port-frequency domain selection matrix is the same as a quantity of mutually orthogonal combinations of a frequency domain unit and a transmit antenna port in the combination of each orthogonal frequency domain unit in all the scheduled frequency domain units and each of the transmit antenna ports, and a column quantity of the first transmit antenna port-frequency domain selection matrix is the same as a quantity of orthogonal transmit antenna ports. The processing module 2101 is further configured to determine the first information based on the first transmit antenna port-frequency domain selection matrix.

In an embodiment, a sending module is configured to: when a transmit antenna port and/or a frequency domain unit that are/is for sending the reference signal change/changes, send second information to the terminal device, where the second information indicates that one or more of the following occupied by the reference signal change: the transmit antenna port of the terminal device or the frequency domain unit.

In an embodiment, the transceiver module 2102 is further configured to receive a second reference signal from the terminal device, where a transmit antenna port and a frequency domain unit that are occupied by the second reference signal are determined based on the frequency domain selection matrix, the transmit antenna port occupied by the second reference signal is all the transmit antenna ports of the terminal device, and the frequency domain unit occupied by the second reference signal is the mutually orthogonal frequency domain units in all the scheduled frequency domain units. The processing module 2101 is further configured to determine a seventh channel matrix based on the second reference signal, where the seventh channel matrix is a channel matrix corresponding to a combination of each of all the receive antenna ports of the communication apparatus 2100, each of all the transmit antenna ports of the terminal device, and each orthogonal frequency domain unit in all the scheduled frequency domain units. The processing module 2101 is further configured to perform orthogonal triangular decomposition on the seventh channel matrix, to obtain a second transmit antenna port-frequency domain selection matrix. The processing module 2101 is further configured to: when the first transmit antenna port-frequency domain selection matrix is inconsistent with the second transmit antenna port-frequency domain selection matrix, determine that one or more of the following for sending the reference signal change: the transmit antenna port or the frequency domain unit.

In an embodiment, the processing module 2101 is further configured to determine an eighth channel matrix based on the second channel matrix and a receive antenna port selection matrix, where the receive antenna port selection matrix is obtained by performing orthogonal triangular decomposition on a receive antenna port base matrix of the communication apparatus 2100. The processing module 2101 is further configured to determine a ninth channel matrix based on the eighth channel matrix, where the ninth channel matrix is a channel matrix obtained by extending the transmit antenna ports of the terminal device in frequency domain, and the ninth channel matrix indicates the corresponding channel state information on all the receive antenna ports of the communication apparatus 2100, all the transmit antenna ports of the terminal device, and the mutually orthogonal frequency domain units in all the scheduled frequency domain units. The processing module 2101 is further configured to determine a first error coefficient based on the third channel matrix and the ninth channel matrix, where the first error coefficient indicates an error of the ninth channel matrix relative to the third channel matrix. The processing module 2101 is further configured to: when the first error coefficient is greater than or equal to a first error threshold, determine that the transmit antenna port for sending the reference signal changes.

In an embodiment, the ninth channel matrix satisfies the following relationship: H2_{ob_sub}=U2_{sub}*Q*V2_{sub}; and

$$H {2}_{check} = U 2 * U {2}_{sub}^{- 1} * H {2}_{ob\_sub} * V {2}_{sub}^{- 1} * V 2 ,$$

where H2_{check} is the ninth channel matrix, H2_{ob_sub} is the eighth channel matrix, V2_{sub} is the transmit antenna port-frequency domain orthogonal base matrix of the terminal device, U2_{sub} is a receive antenna port orthogonal base matrix of the communication apparatus 2100, Q is a time domain coefficient matrix,

$$U {2}_{sub}^{- 1}$$

is an inverse matrix of U2_{sub}, U2 is the receive antenna port base matrix of the communication apparatus 2100,

$$V {2}_{sub}^{- 1}$$

is the inverse matrix of V2_{sub}, and V2 is the transmit antenna port-frequency domain base matrix of the terminal device.

In an embodiment, the first error coefficient satisfies the following relationship:

$$E 1 = \frac{\vert H {2}_{est} - H {2}_{check} \vert}{\vert H {2}_{est} \vert} ,$$

where E1 is the first error coefficient, H2ₑₛₜ is the third channel matrix, and H2_{check} is the ninth channel matrix.

In an embodiment, the transceiver module 2102 is further configured to receive a third reference signal from the terminal device, where a frequency domain unit occupied by the third reference signal is a second frequency domain unit, a transmit antenna port occupied by the third reference signal is a second transmit antenna port, and a combination of the second frequency domain unit and the second transmit antenna port is different from the combination of the first frequency domain unit and the first transmit antenna port. The processing module 2101 is further configured to determine a first channel coefficient on the second transmit antenna port and the second frequency domain unit based on the third reference signal. The processing module 2101 is further configured to obtain a second channel coefficient on the second transmit antenna port and the second frequency domain unit through estimation based on the second channel matrix. The processing module 2101 is further configured to determine a second error coefficient based on the first channel coefficient and the second channel coefficient, where the second error coefficient indicates an error of the first channel coefficient relative to the second channel coefficient. The processing module 2101 is further configured to: when the second error coefficient is greater than or equal to a second error threshold, determine that the transmit antenna port for sending the reference signal changes.

In an embodiment, the second error coefficient satisfies the following relationship:

$$E 2 = \frac{\vert h {1}_{est} - h {1}_{check} \vert}{\vert h {1}_{est} \vert} ,$$

where E2 is the second error coefficient, h1_{check} is the first channel coefficient, and h1ₑₛₜ is the second channel coefficient.

In an embodiment, the transceiver module 2102 is further configured to send third information to the terminal device, where the third information indicates the combination of the second frequency domain unit and the second transmit antenna port.

In an embodiment, the transceiver module 2102 is further configured to receive a fourth reference signal from the terminal device, where a frequency domain unit occupied by the fourth reference signal is a third frequency domain unit, a transmit antenna port occupied by the fourth reference signal is a third transmit antenna port, and the third frequency domain unit is different from the first frequency domain unit. The processing module 2101 is further configured to determine a third channel coefficient based on the fourth reference signal. The processing module 2101 is further configured to estimate a fourth channel coefficient on the third transmit antenna port and the third frequency domain unit based on the second channel matrix. The processing module 2101 is further configured to determine a third error coefficient based on the third channel coefficient and the fourth channel coefficient, where the third error coefficient indicates an error of the fourth channel coefficient relative to the third channel coefficient. The processing module 2101 is further configured to: when the third error coefficient is greater than or equal to a third error threshold, determine that the frequency domain unit for sending the reference signal changes.

In an embodiment, the third error coefficient satisfies the following relationship:

$$E 3 = \frac{\vert {h2}_{est} - h {2}_{check} \vert}{\vert {h2}_{est} \vert} ,$$

where E3 is the third error coefficient, h2_{check} is the third channel coefficient, and h2ₑₛₜ is the fourth channel coefficient.

In an embodiment, the processing module 2101 is further configured to send fourth information to the terminal device, where the fourth information indicates a combination of the third frequency domain unit and the third transmit antenna port.

In an embodiment, the transceiver module 2102 may include a receiving module and the sending module (not shown in FIG. 21). The transceiver module 2102 is configured to implement a sending function and a receiving function of the communication apparatus 2100.

In an embodiment, the communication apparatus 2100 may further include a storage module (not shown in FIG. 21). The storage module stores a program or instructions. When the processing module 2101 executes the program or the instructions, the communication apparatus 2100 is enabled to perform the function of the network device in the communication method shown in FIG. 2.

It should be understood that, the processing module 2101 in the communication apparatus 2100 may be implemented by a processor or a processor-related circuit component, and may be a processor or a processing unit; and the transceiver module 2102 may be implemented by a transceiver or a transceiver-related circuit component, and may be a transceiver or a transceiver unit.

It should be noted that, the communication apparatus 2100 may be a network device, may be a chip (system) or another part or component that may be disposed in the network device, or may be an apparatus including the network device. This is not limited in this application.

In addition, for technical effects of the communication apparatus 2100, refer to the technical effects of the communication method shown in FIG. 2. Details are not described herein again.

For example, FIG. 22 is a diagram 2 of a structure of a communication apparatus according to an embodiment of this application. The communication apparatus may be a terminal device or a network device, or may be a chip (system) or another part or component that may be disposed in the terminal device or the network device. As shown in FIG. 22, the communication apparatus 2200 may include a processor 2201. In an embodiment, the communication apparatus 2200 may further include a memory 2202 and/or a transceiver 2203. The processor 2201 is coupled to the memory 2202 and the transceiver 2203, for example, may be connected through a communication bus.

The following describes each part in the communication apparatus 2200 in detail with reference to FIG. 22.

The processor 2201 is a control center of the communication apparatus 2200, and may be one processor, or may be a general term of a plurality of processing elements. For example, the processor 2201 is one or more central processing units (CPUs), or may be an application-specific integrated circuit (ASIC) or one or more integrated circuits configured to implement embodiments of this application, for example, one or more digital signal processors (DSPs), or one or more field programmable gate arrays (FPGAs).

In an embodiment, the processor 2201 may perform various functions of the communication apparatus 2200 by running or executing a software program stored in the memory 2202 and invoking data stored in the memory 2202.

During specific implementation, in an embodiment, the processor 2201 may include one or more CPUs, for example, a CPU 0 and a CPU 1 shown in FIG. 22.

During specific implementation, in an embodiment, the communication apparatus 2200 may alternatively include a plurality of processors, for example, the processor 2201 and a processor 2204 shown in FIG. 22. Each of the processors may be a single-core processor (single-CPU), or may be a multi-core processor (multi-CPU). The processor herein may be one or more devices, circuits, and/or processing cores configured to process data (for example, computer program instructions).

The memory 2202 is configured to store a software program for performing the solutions in this application, and the processor 2201 controls execution. For a specific implementation, refer to the foregoing method embodiment. Details are not described herein again.

In an embodiment, the memory 2202 may be a read-only memory (ROM) or another type of static storage device that may store static information and instructions, or a random access memory (RAM) or another type of dynamic storage device that may store information and instructions, or may be an electrically erasable programmable read-only memory (EEPROM), a compact disc read-only memory (CD-ROM) or other compact disc storage, optical disc storage (including a compressed optical disc, a laser disc, an optical disc, a digital versatile disc, a Blu-ray disc, or the like), a magnetic disk storage medium or another magnetic storage device, or any other medium that can be for carrying or storing expected program code in a form of instructions or a data structure and that can be accessed by a computer, but is not limited thereto. The memory 2202 may be integrated with the processor 2201, or may exist independently and is coupled to the processor 2201 through an interface circuit (not shown in FIG. 22) of the communication apparatus 2200. This is not specifically limited in this embodiment of this application.

The transceiver 2203 is configured to communicate with another communication apparatus. For example, the communication apparatus 2200 is the terminal device, and the transceiver 2203 may be configured to communicate with a network device or communicate with another terminal device. For another example, the communication apparatus 2200 is the network device, and the transceiver 2203 may be configured to communicate with a terminal device or communicate with another network device.

In an embodiment, the transceiver 2203 may include a receiver and a transmitter (not separately shown in FIG. 22). The receiver is configured to implement a receiving function, and the transmitter is configured to implement a sending function.

In an embodiment, the transceiver 2203 may be integrated with the processor 2201, or may exist independently and is coupled to the processor 2201 through the interface circuit (not shown in FIG. 22) of the communication apparatus 2200. This is not specifically limited in this embodiment of this application.

It should be noted that the structure of the communication apparatus 2200 shown in FIG. 22 does not constitute a limitation on the communication apparatus. An actual communication apparatus may include more or fewer parts than those shown in the figure, combine some parts, or have different part arrangements.

In addition, for technical effects of the communication apparatus 2200, refer to the technical effects of the communication method in the foregoing method embodiment. Details are not described herein again.

It should be understood that the processor in embodiments of this application may be a central processing unit (CPU), or the processor may be another general-purpose processor, a digital signal processor (DSP), an application-specific integrated circuit (ASIC), a field programmable gate array (FPGA) or another programmable logic device, a discrete gate or a transistor logic device, a discrete hardware component, or the like. The general-purpose processor may be a microprocessor, or the processor may be any conventional processor or the like.

It should be further understood that the memory in embodiments of this application may be a volatile memory or a nonvolatile memory, or may include both the volatile memory and the nonvolatile memory. The nonvolatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), used as an external cache. By way of example but not limitative description, random access memories (RAMs) in many forms are available, for example, a static random access memory (SRAM), a dynamic random access memory (DRAM), a synchronous dynamic random access memory (SDRAM), a double data rate synchronous dynamic random access memory DDR SDRAM), an enhanced synchronous dynamic random access memory (ESDRAM), a synchlink dynamic random access memory (SLDRAM), and a direct rambus random access memory (DR RAM).

All or some of the foregoing embodiments may be implemented by using software, hardware (for example, a circuit), firmware, or any other combination thereof. When software is used to implement embodiments, the foregoing embodiments may be implemented completely or partially in a form of a computer program product. The computer program product includes one or more computer instructions or computer programs. When the computer instructions or the computer programs are loaded and executed on the computer, the procedure or functions according to embodiments of this application are all or partially generated. The computer may be a general-purpose computer, a dedicated computer, a computer network, or another programmable apparatus. The computer instructions may be stored in a computer-readable storage medium, or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by the computer, or a data storage device, for example, a server or a data center, integrating one or more usable media. The usable medium may be a magnetic medium (for example, a floppy disk, a hard disk, or a magnetic tape), an optical medium (for example, a DVD), or a semiconductor medium. The semiconductor medium may be a solid-state drive.

It should be understood that the term “and/or” in this specification describes only an association relationship between associated objects, and indicates that three relationships may exist. For example, A and/or B may indicate the following three cases: Only A exists, both A and B exist, and only B exists, where A and B may be singular or plural. In addition, the character “/” in this specification usually indicates an “or” relationship between the associated objects, but may also indicate an “and/or” relationship. For details, refer to the context for understanding.

In this application, “at least one” means one or more, and “a plurality of” means two or more than two. “At least one of the following” or a similar expression thereof indicates any combination of these items, and includes a single item or any combination of plural items. For example, at least one of a, b, or c may indicate: a, b, c, a and b, a and c, b and c, or a, b, and c, where a, b, and c may be singular or plural.

It should be understood that, in embodiments of this application, sequence numbers of the foregoing processes do not mean execution sequences. The execution sequences of the processes should be determined based on functions and internal logic of the processes, and should not constitute any limitation on the implementation processes of embodiments of this application.

A person of ordinary skill in the art may be aware that, with reference to the units and the algorithm operations in the examples described in embodiments disclosed in this specification, this application can be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of this application.

It may be clearly understood by a person skilled in the art that, for the purpose of convenient and brief description, for a detailed working process of the foregoing system, apparatus, and unit, refer to a corresponding process in the foregoing method embodiments. Details are not described herein again.

In the several embodiments provided in this application, it should be understood that the disclosed system, apparatus, and method may be implemented in other manners. For example, the foregoing apparatus embodiment is merely an example. For example, the division into the units is merely logical function division, and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electrical, mechanical, or other forms.

The units described as separate parts may or may not be physically separate, and parts displayed as units may or may not be physical units, that is, may be located in one location, or may be distributed on a plurality of network units. Some or all of the units may be selected based on actual requirements to achieve the objectives of the solutions in embodiments.

In addition, functional units in embodiments of this application may be integrated into one processing unit, each of the units may exist alone physically, or two or more units are integrated into one unit.

When the functions are implemented in the form of a software functional unit and sold or used as an independent product, the functions may be stored in a computer-readable storage medium. Based on such an understanding, the technical solutions in this application essentially, the part contributing to the conventional technology, or some of the technical solutions may be implemented in a form of a software product. The computer software product is stored in a storage medium, and includes several instructions for instructing a computer device (which may be a personal computer, a server, a network device, or the like) to perform all or some of the operations of the methods in embodiments of this application. The foregoing storage medium includes any medium that may store program code, for example, a USB flash drive, a removable hard disk, a read-only memory (ROM), a random access memory (random access memory, RAM), a magnetic disk, or an optical disc.

The foregoing descriptions are merely specific implementations of this application, but the protection scope of this application is not limited thereto. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A communication method, wherein the method comprises:
receiving first information from a network device, wherein the first information indicates at least one combination of a first transmit antenna port and a first frequency domain unit that are used by a terminal device to send a reference signal to the network device; each combination comprises one first transmit antenna port and one first frequency domain unit; and all first transmit antenna ports in the at least one combination are a part of all transmit antenna ports of the terminal device, and/or all first frequency domain units in the at least one combination are a part of all scheduled frequency domain units; and
sending a first reference signal to the network device based on the combination that is of the first transmit antenna port and the first frequency domain unit and that is indicated by the first information, wherein the first reference signal is for determining a first channel matrix, and the first channel matrix indicates channel state information corresponding to all the transmit antenna ports of the terminal device, all receive antenna ports of the network device, and all the scheduled frequency domain units.

2. The method according to claim 1, wherein the first channel matrix is a channel matrix whose dimension is MN*P, wherein M is a quantity of all the receive antenna ports of the network device, N is a quantity of all the transmit antenna ports of the terminal device, P is a quantity of all the scheduled frequency domain units, and M, N, and P are all positive integers.

3. The method according to claim 1, wherein the method further comprises:
receiving second information from the network device, wherein the second information indicates that one or more of the following occupied by the reference signal change: a transmit antenna port of the terminal device or a frequency domain unit.

4. The method according to claim 3, wherein the method further comprises:
sending a second reference signal to the network device, wherein the second reference signal is for determining whether the transmit antenna port that is of the terminal device and that is occupied by the to-be-sent reference signal changes, a transmit antenna port and a frequency domain unit that are occupied by the second reference signal are determined based on a frequency domain selection matrix, the frequency domain selection matrix is obtained by decomposing a frequency domain orthogonal base matrix, the transmit antenna port occupied by the second reference signal is all the transmit antenna ports of the terminal device, and the frequency domain unit occupied by the second reference signal is orthogonal frequency domain units in all the scheduled frequency domain units.

5. The method according to claim 3, wherein the method further comprises:
sending a third reference signal to the network device, wherein the third reference signal is for determining whether the transmit antenna port occupied by the to-be-sent reference signal changes, a frequency domain unit occupied by the third reference signal is a second frequency domain unit, a transmit antenna port occupied by the third reference signal is a second transmit antenna port, and a combination of the second frequency domain unit and the second transmit antenna port is different from the combination of the first frequency domain unit and the first transmit antenna port.

6. The method according to claim 5, wherein sending the third reference signal to the network device comprises:
when a current time point reaches a preset moment, it is detected that a modulation and coding order is less than a preset modulation and coding threshold, it is detected that a block error rate is greater than a block error rate threshold, it is detected that a signal to interference plus noise ratio is greater than or equal to a noise threshold, or it is detected that a quantity of transmitted streams is less than or equal to a stream quantity threshold, sending the third reference signal to the network device.

7. The method according to claim 5, wherein before sending the third reference signal to the network device, the method further comprises:
receiving third information from the network device, wherein the third information indicates the combination of the second frequency domain unit and the second transmit antenna port.

8. A communication method, wherein the method comprises:
sending first information to a terminal device, wherein the first information indicates at least one combination of a first transmit antenna port and a first frequency domain unit that are used by the terminal device to send a reference signal to a network device; each combination comprises one first transmit antenna port and one first frequency domain unit; and all first transmit antenna ports in the at least one combination are a part of all transmit antenna ports of the terminal device, and/or all first frequency domain units in the at least one combination are a part of all scheduled frequency domain units;
receiving, on the first frequency domain unit, a first reference signal sent through the first transmit antenna port; and
determining a first channel matrix based on the first reference signal, wherein the first channel matrix indicates channel state information corresponding to all the transmit antenna ports of the terminal device, all receive antenna ports of the network device, and all the scheduled frequency domain units.

9. The method according to claim 8, wherein the first channel matrix is a channel matrix whose dimension is MN*P, wherein M is a quantity of all the receive antenna ports of the network device, N is a quantity of all the transmit antenna ports of the terminal device, P is a quantity of all the scheduled frequency domain units, and M, N, and P are all positive integers.

10. The method according to claim 8, wherein determining the first channel matrix based on the first reference signal comprises:
determining a second channel matrix based on the first reference signal, wherein the second channel matrix is a channel matrix obtained by extending all the transmit antenna ports of the terminal device in frequency domain, and the second channel matrix indicates channel state information corresponding to all the receive antenna ports of the network device, all the transmit antenna ports of the terminal device, and mutually orthogonal frequency domain units in all the scheduled frequency domain units; and
determining the first channel matrix based on the second channel matrix.

11. The method according to claim 10, wherein determining the first channel matrix based on the second channel matrix comprises:
obtaining a third channel matrix through estimation based on the second channel matrix, wherein the third channel matrix is a channel matrix obtained by extending all the transmit antenna ports of the terminal device in frequency domain, and the third channel matrix indicates an estimation result of the channel state information corresponding to all the receive antenna ports of the network device, all the transmit antenna ports of the terminal device, and the mutually orthogonal frequency domain units in all the scheduled frequency domain units;
determining a fourth channel matrix based on the third channel matrix, wherein the fourth channel matrix is a channel matrix obtained by extending all the transmit antenna ports of the terminal device on all the receive antenna ports of the network device; and
determining the first channel matrix based on the fourth channel matrix, a frequency domain base matrix, and a frequency domain orthogonal base matrix.

12. The method according to claim 11, wherein the first channel matrix satisfies the following relationship:
$$H {1}_{est} = H {1}_{sub} * V {1}_{sub}^{- 1} * V 1 ; and$$
$$H 1 \approx H {1}_{est} ,$$
wherein H1ₑₛₜ indicates an estimation result of the channel state information corresponding to all the transmit antenna ports of the terminal device, all the receive antenna ports of the network device, and all the scheduled frequency domain units, H1_{sub} is the fourth channel matrix, V1_{sub} is the frequency domain orthogonal base matrix
$$V {1}_{sub}^{- 1}$$
is an inverse matrix of V1_{sub}, V1 is the frequency domain base matrix, and H1 is the first channel matrix.

13. The method according to claim 12, wherein both a row quantity and a column quantity of the frequency domain orthogonal base matrix are equal to a quantity of the mutually orthogonal frequency domain units in all the scheduled frequency domain units, and both a row quantity and a column quantity of the inverse matrix of the frequency domain orthogonal base matrix are equal to the quantity of the mutually orthogonal frequency domain units in all the scheduled frequency domain units.

14. The method according to claim 11, wherein the third channel matrix satisfies the following relationship:
$$H {2}_{est} = H {2}_{ob} * V {2}_{sub}^{- 1} * V 2 ,$$
wherein H2ₑₛₜ is the third channel matrix, H2_{ob} is the second channel matrix, V2 is a transmit antenna port-frequency domain base matrix of the terminal device, and
$$V {2}_{sub}^{- 1}$$
is an inverse matrix of a transmit antenna port-frequency domain orthogonal base matrix V2_{sub} of the terminal device.

15. A communication apparatus, wherein the communication apparatus comprises: at least one processor configured to execute programming instructions to enable the communication apparatus to implement operations comprising:
receiving first information from a network device, wherein the first information indicates at least one combination of a first transmit antenna port and a first frequency domain unit that are used by a terminal device to send a reference signal to the network device; each combination comprises one first transmit antenna port and one first frequency domain unit; and all first transmit antenna ports in the at least one combination are a part of all transmit antenna ports of the terminal device, and/or all first frequency domain units in the at least one combination are a part of all scheduled frequency domain units; and
sending a first reference signal to the network device based on the combination that is of the first transmit antenna port and the first frequency domain unit and that is indicated by the first information, wherein the first reference signal is for determining a first channel matrix, and the first channel matrix indicates channel state information corresponding to all the transmit antenna ports of the terminal device, all receive antenna ports of the network device, and all the scheduled frequency domain units.

16. The communication apparatus according to claim 15, wherein the first channel matrix is a channel matrix whose dimension is MN*P, wherein M is a quantity of all the receive antenna ports of the network device, N is a quantity of all the transmit antenna ports of the terminal device, P is a quantity of all the scheduled frequency domain units, and M, N, and P are all positive integers.

17. The communication apparatus according to claim 15, wherein the operations comprise:
receiving second information from the network device, wherein the second information indicates that one or more of the following occupied by the reference signal change: a transmit antenna port of the terminal device or a frequency domain unit.

18. The communication apparatus according to claim 17, wherein the operations comprise:
sending a second reference signal to the network device, wherein the second reference signal is for determining whether the transmit antenna port that is of the terminal device and that is occupied by the to-be-sent reference signal changes, a transmit antenna port and a frequency domain unit that are occupied by the second reference signal are determined based on a frequency domain selection matrix, the frequency domain selection matrix is obtained by decomposing a frequency domain orthogonal base matrix, the transmit antenna port occupied by the second reference signal is all the transmit antenna ports of the terminal device, and the frequency domain unit occupied by the second reference signal is orthogonal frequency domain units in all the scheduled frequency domain units.

19. The communication apparatus according to claim 17, wherein the operations comprise:
sending a third reference signal to the network device, wherein the third reference signal is for determining whether the transmit antenna port occupied by the to-be-sent reference signal changes, a frequency domain unit occupied by the third reference signal is a second frequency domain unit, a transmit antenna port occupied by the third reference signal is a second transmit antenna port, and a combination of the second frequency domain unit and the second transmit antenna port is different from the combination of the first frequency domain unit and the first transmit antenna port.

20. The communication apparatus according to claim 19, wherein sending the third reference signal to the network device comprises:
when a current time point reaches a preset moment, it is detected that a modulation and coding order is less than a preset modulation and coding threshold, it is detected that a block error rate is greater than a block error rate threshold, it is detected that a signal to interference plus noise ratio is greater than or equal to a noise threshold, or it is detected that a quantity of transmitted streams is less than or equal to a stream quantity threshold, sending the third reference signal to the network device.
